(19) United States
(12) Patent Application Publication
(10) Pub. No.: US 2026/0214651 A1
(43) Pub. Date: Jul. 23, 2026

(54) INTER-BAND INTERFERENCE AVOIDANCE AND MITIGATION SCHEMES

(71) Applicant: QUALCOMM Incorporated, San Diego, CA (US)

(72) Inventors: Qian ZHANG, Basking Ridge, NJ (US); Tao LUO, San Diego, CA (US); Navid ABEDINI, Basking Ridge, NJ (US); Junyi LI, Greentown, PA (US); Igor GUTMAN, Hod HaSharon (IL); Xiaoxia ZHANG, San Diego, CA (US); Qing LI, Princeton Junction, NJ (US); Mostafa KHOSHNEVISAN, San Diego, CA (US); Jelena DAMNJANOVIC, Del Mar, CA (US); Sony AKKARAKARAN, Poway, CA (US)

(21) Appl. No.: 19/031,073

(22) Filed: Jan. 17, 2025

(51) Int. Cl. H04W 72/0453; H04B 17/19; H04W 52/24

(52) U.S. Cl. CPC H04W 72/0453; H04B 17/19; H04W 52/243

(57) ABSTRACT

The apparatus may be configured to receive a first allocation of UL resources spanning a first range of frequencies, receive a second allocation of DL resources spanning a second range of frequencies, and adjust, based on the DL resources including at least one harmonic frequency resource harmonic to the UL resources, one or more of an UL transmission in the UL resources or a reception of a DL transmission in the DL resources, where the adjusting is associated with one or more of: a DL rate matching around the at least one harmonic frequency resource, an increased DL transmission power of the DL transmission in the at least one harmonic frequency resource, a reduced UL transmission power for the UL transmission associated with the at least one harmonic frequency resource, or a lower order MCS for the DL transmission in the at least one harmonic frequency resource.

### TECHNICAL FIELD

The present disclosure relates generally to communication systems, and more particularly, to wireless communication that includes transmission and reception in different frequency bands.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR, for example, is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of future telecommunication technologies, such as 6G, may be based on aspects of 5G NR and/or LTE. There exists a need for further improvements in 5G NR and additional telecommunication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive, from a network node, a first allocation of uplink (UL) resources spanning a first range of frequencies within a first frequency band, receive a second allocation of downlink (DL) resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a reception of a DL transmission in the DL resources, where the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order modulation and coding scheme (MCS) for the DL transmission in the at least one harmonic frequency resource.

In an aspect of the disclosure, a method, a computer-readable medium, and an apparatus are provided. The apparatus may be a network node such as a base station configured to transmit, for a UE, a first allocation of UL resources spanning a first range of frequencies within a first frequency band, transmit a second allocation of DL resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a DL transmission in the DL resources, where the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order MCS for the DL transmission in the at least one harmonic frequency resource.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and

an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates example aspects of an RF front end for a transceiver, such as a transceiver of a UE.

FIG. 5A is a diagram illustrating a base station (or one or more components of a base station, which may be referred to as a network node) exchanging downlink and uplink communication, with a UE.

FIG. 5B is a diagram showing an example of DC in which a UE is served by a first network node and a second network node.

FIG. 5C illustrates that the frequency bands and may be separate (e.g., non-overlapping) frequency bands and may be separated by one or more frequency bands.

FIG. 6A shows a diagram showing a transmission by the UE at a first frequency in a first frequency band.

FIG. 6B illustrates an example in which the UE receives a transmission that may only partially overlap with the leakage due to the UE's transmission.

FIG. 7A is a diagram illustrating a first configuration of allocations of UL and DL frequency resources that are fully overlapping from the perspective of the UL frequency resources and partially overlapping from the perspective of the DL frequency resources in accordance with some aspects of the disclosure.

FIG. 7B is a diagram illustrating a first configuration of allocations of UL and DL frequency resources that are partially overlapping from the perspective of the UL frequency resources and fully overlapping from the perspective of the DL frequency resources in accordance with some aspects of the disclosure.

FIG. 7C is a diagram illustrating a first configuration of allocations of UL and DL frequency resources that are fully overlapping from the perspective of the UL frequency resources and fully overlapping from the perspective of the DL frequency resources in accordance with some aspects of the disclosure.

FIG. 7D is a diagram illustrating a first configuration of allocations of UL and DL frequency resources that are partially overlapping from the perspective of the UL frequency resources and partially overlapping from the perspective of the DL frequency resources in accordance with some aspects of the disclosure.

FIG. 7E is a set of diagrams illustrating an example interference associated with allocated time-and-frequency resources for UL in a first band and DL in a second band in accordance with some aspects of the disclosure.

FIG. 8 is a call flow diagram illustrating a method of wireless communication in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an apparatus.

FIG. 14 is a diagram illustrating an example of a hardware implementation for a network entity.

### DETAILED DESCRIPTION

In certain aspects of wireless communication, one or both of a base station and a UE may engage in frequency division duplex (FDD) communication, in which one frequency band is used for uplink communication and a different frequency band is used for downlink communication. Inter-band carrier aggregation (CA) is another example in which wireless communication may be exchanged on different frequency bands. As another example, a UE configured for dual connectivity (DC) may be served by one RAN node (which may be referred to as a network node) as a primary node and another RAN node as a secondary node. The UE may exchange communication with the RAN nodes using different frequency bands, for example. In some aspects, a network node may transmit downlink communication to a UE in a first frequency band, such as a 7 GHz frequency band and the UE may transmit uplink communication to the network node (e.g., a same base station or a different base station), in a second frequency band, such as a 3.5 GHz frequency band.

Even though the downlink reception and the uplink transmission are in different frequency bands, the transmission by the UE may cause interference (e.g., self-interference) to the UE's reception due to a harmonic frequency. The interference may be referred to as self-interference because the UE's transmission causes the interference to its own reception. In some aspects, the reception may be referred to as simultaneous reception (e.g., overlapping at least partially in time with the UE's transmission in the other frequency band). The inter-band transmission and reception is different than full-duplex operation, which involves transmission and reception in the same frequency band or same time division duplex (TDD) carrier, in contrast to the inter-band transmission and reception in different frequency bands. The inter-band self-interference may be significant at the UE, e.g., if flexible TDD scheduling is used for the UE's communication in the two frequency bands.

In some aspects, self-interference associated with inter-band transmission and reception may be based on a transmission by the UE at a first frequency (f₁) in a first frequency band. The first frequency (f₁) may be referred to herein as a fundamental frequency, an initial frequency, or a transmission frequency and may be associated with a frequency resource allocated for an UL transmission, which may be referred to as an allocated UL resource, an allocated UL frequency resource, or an impacting and/or interfering UL resource. In some aspects, the first frequency (f₁) may be associated with leakage (or interference) that may be experienced at the UE's receiver based on a harmonic frequency (e.g., f₂) of the frequency (f₁) used to transmit the transmission. A second order, or second degree, harmonic frequency associated with the first frequency (f₁) is f₂=2*f₁ and the interference associated with the second order harmonic frequency may be experienced in a range of frequencies around f₂. A fourth order, or fourth degree, harmonic frequency associated with the first frequency (f₁) may also occur at f₂=3*f₁−f₁ and the interference associated with the fourth order harmonic frequency may be experienced in a range of frequencies around f₂. In the example in which f₁=3.5 GHZ, the interference will be experienced at f₂=7 GHz. For reception that is scheduled in the second frequency band, but not overlapping with a (leakage, or interference, associated with a) harmonic frequency of the first frequency in the first frequency band at which the UE transmits, the UE may not experience self-interference. If the UE is receiving a transmission in a second frequency band at a second frequency that overlaps, at least partially, with the interference due to (or associated with) the harmonic of f₁ (e.g., at f₂), the UE harmonic causes self-interference to the UE's reception, even though the transmission is in a different frequency band than the reception. For example, intermodulation distortion (IMD) (e.g., TX IMD) based on the transmission at the frequency f₁ may be represented as:

$$TX IMD = {α}_{2} \cdot {x}_{imd 2} + {α}_{4} \cdot {x}_{imd 4} + … = LPF ( {α}_{2} \cdot {re ( x \cdot {e}^{j \cdot 2 \cdot π \cdot {f}_{1}} )}^{2} + {α}_{4} \cdot {re ( x \cdot {e}^{j \cdot 2 \cdot π \cdot {f}_{1}} )}^{4} + … ) = {α}_{2} \cdot {x}^{2} \cdot {e}^{j \cdot 2 \cdot π \cdot {f}_{2}} + {α}_{4} \cdot {x}^{2} \cdot {\vert x \vert}^{2} \cdot {e}^{j \cdot 2 \cdot π \cdot {f}_{2}} + …$$

The above equation for TX IMD shows two orders of IMD associated with the harmonic frequency (e.g., f₂) of the first frequency f₁. In the equation, α₁ for i∈(2,4) represents a coefficient associated with the effect of the corresponding order of the IMD (e.g., imd2 and imd4), so that α₂ is for the second order harmonic, α₂ represents the square of the signal at f₁, and j is the imaginary number. In the equation, imd2 corresponds to the second order IMD and imd4 corresponds to the fourth order IMD. As shown, imd2 and imd4 may both occur on, or have products associated with, the harmonic frequency (f₂).

The interference for communication in the two frequency bands may not be symmetric. For example, the transmission by the UE using frequency resources in the C band may cause self-interference to the UE's reception in a 6-8 GHz band due to a second order (or fourth order) harmonic from the C band. However, a transmission in the 6-8 GHz band may not cause self-interference to the UE's reception in the C band.

Various aspects relate generally to cases of inter-band aggregation, for which UL transmission from a UE may create self-interference to DL reception at the UE. Multiple options for performing a rate-matching are provided, such as defining rules for UE autonomous rate-matching without dynamic indication from the network. Some aspects relate to options for self-interference mitigation, such as increasing DL transmission power, decreasing UL transmission power, and/or decreasing a modulation and coding scheme (e.g., decreasing the order or index associated with the MCS) for frequencies experiencing self-interference. In some examples, a UE may be configured to receive, from a network node, a first allocation of UL resources spanning a first range of frequencies within a first frequency band, receive a second allocation of DL resources spanning a second range of frequencies within a second frequency band that includes a harmonic frequency of the first frequency band, and adjust, based on the DL frequency resources including at least one harmonic frequency resource that is harmonic to the UL frequency resources, one or more of an UL transmission in the UL frequency resources or a reception of a DL transmission in the DL frequency resources, where the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order MCS for the DL transmission in the at least one harmonic frequency resource. In some aspects, a network node, or base station, may be configured to transmit, for a UE, a first allocation of UL resources spanning a first range of frequencies within a first frequency band, transmit a second allocation of DL resources spanning a second range of frequencies within a second frequency band that includes a harmonic frequency of the first frequency band, and adjust, based on the DL frequency resources including at least one harmonic frequency resource that is harmonic to the UL frequency resources, one or more of an UL transmission in the UL resources or a DL transmission in the DL frequency resources, where the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order MCS for the DL transmission in the at least one harmonic frequency resource.

Aspects presented herein help to alleviate (e.g., avoid or mitigate) inter-band self-interference at the UE in a way that avoids added UE complexity or reduction in UE flexibility. For example, the aspects presented herein help to alleviate intra-UE inter-band self-interference in ways that can be applicable for various types of UEs, including UEs having limited capabilities. The aspects presented herein may help to reduce, avoid, and/or mitigate intra-UE inter-band interference (e.g., self-interference) for FDD operation in different frequency bands, inter-band CA, and/or inter-band DC, among other examples.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems may be arranged in multiple manners with various components or constituent parts. As one example of a communication system to illustrate the concept, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station. Aspects presented herein are not limited to 5G NR, and may be applicable, for example, to 6G or other technologies. An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

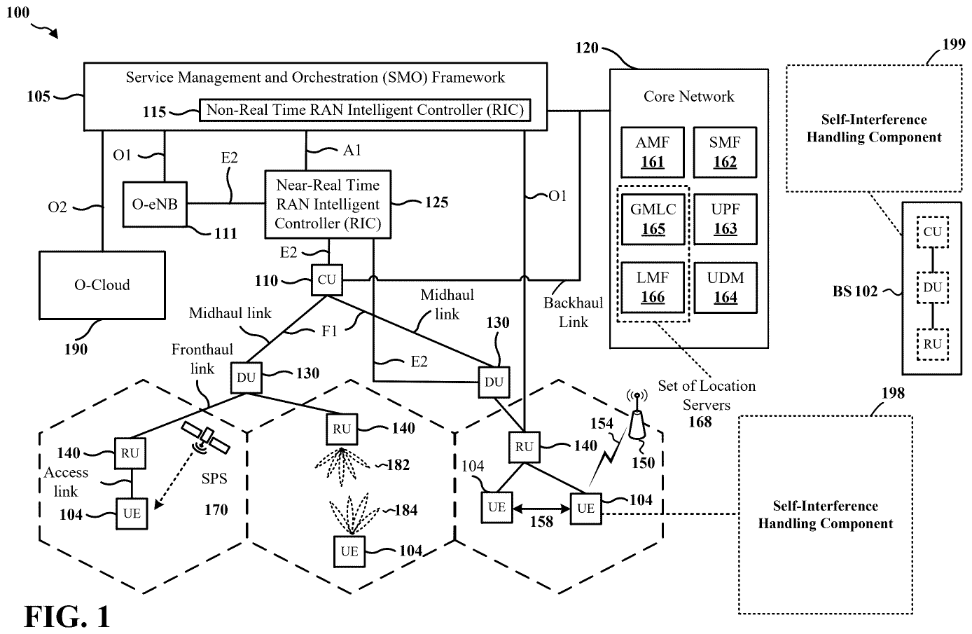

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN

Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, two initial operating bands have been identified as frequency range designations FR1 (410 MHz-7.125 GHz) and FR2 (24.25 GHz-52.6 GHZ), e.g., for use in 5G NR. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Some studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a self-interference handling component 198 that may be configured to receive, from a network node, a first allocation of UL resources spanning a first range of frequencies within a first frequency band, receive a second allocation of DL resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a reception of a DL transmission in the DL resources, where the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order MCS for the DL transmission in the at least one harmonic frequency resource. In certain aspects, the base station 102 may have a self-interference handling component 199 that may be configured to transmit, for a UE, a first allocation of UL resources spanning a first range of frequencies within a first frequency band, transmit a second allocation of DL resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a DL transmission in the DL resources, where the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order MCS for the DL transmission in the at least one harmonic frequency resource. Although some of the following description may be focused on 5G NR to illustrate various example aspects of wireless communication, the concepts described herein may be applicable to other similar areas, such as 6G, LTE, LTE-A, CDMA, GSM, and other wireless technologies.

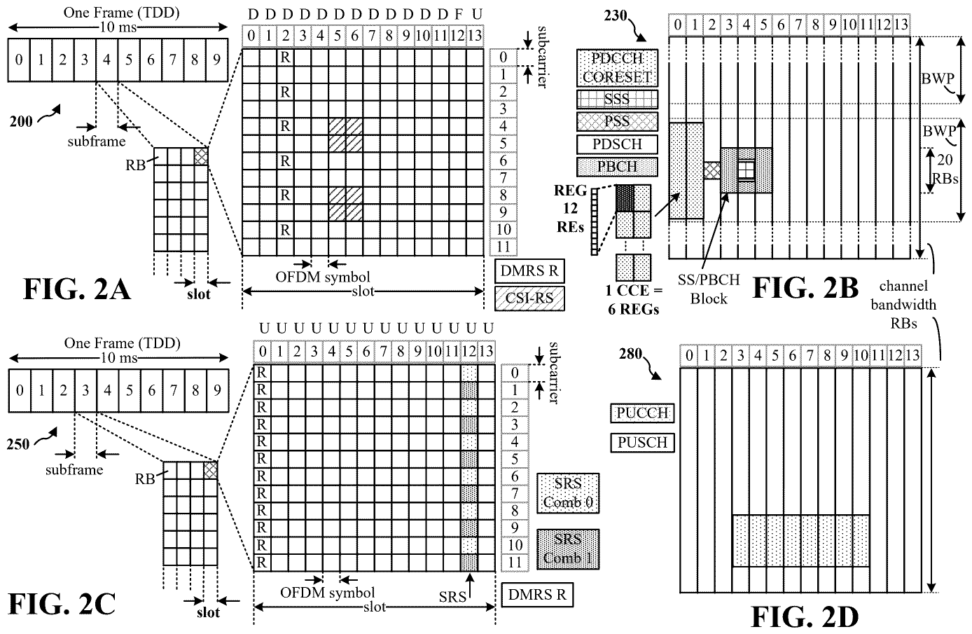

FIG. 2A is a diagram 200 illustrating an example of a first subframe within a frame structure. The frame structure illustrated in FIG. 2A-2D are for 5G NR to illustrate various aspects of an example frame structure. The concepts of the present disclose are not limited to 5G NR, and may be applicable, e.g., for 6G or future technologies. FIG. 2B is a diagram 230 illustrating an example of DL channels within a 5G NR subframe, as a non-limiting example. FIG. 2C is a diagram 250 illustrating an example of a second subframe within a 5G NR frame structure, as a non-limiting example. FIG. 2D is a diagram 280 illustrating an example of UL channels within a 5G NR subframe, as a non-limiting example. In some aspects, a frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

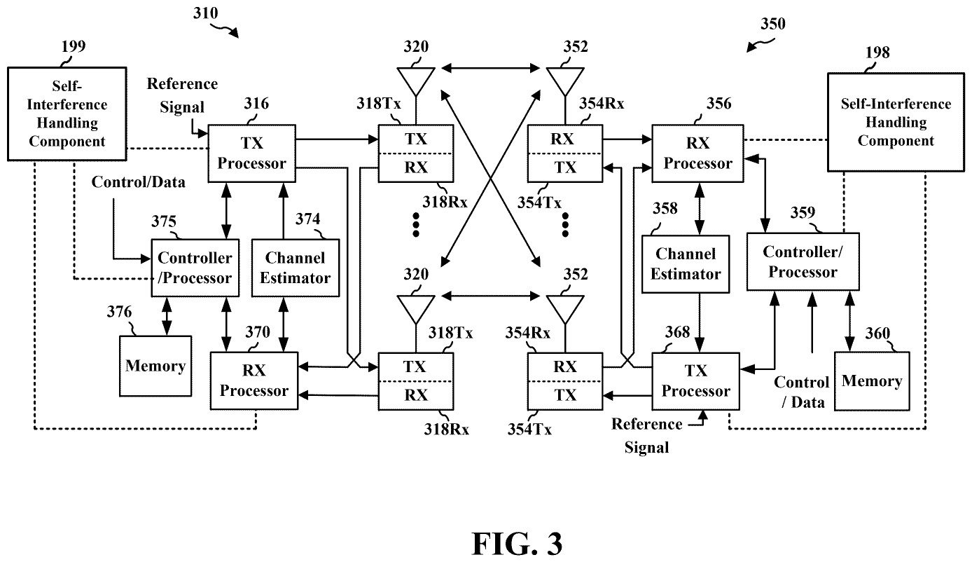

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the self-interference handling component 198 of FIG. 1.

At least one of the TX processor 316, the RX processor 370, and the controller/processor 375 may be configured to perform aspects in connection with the self-interference handling component 199 of FIG. 1.

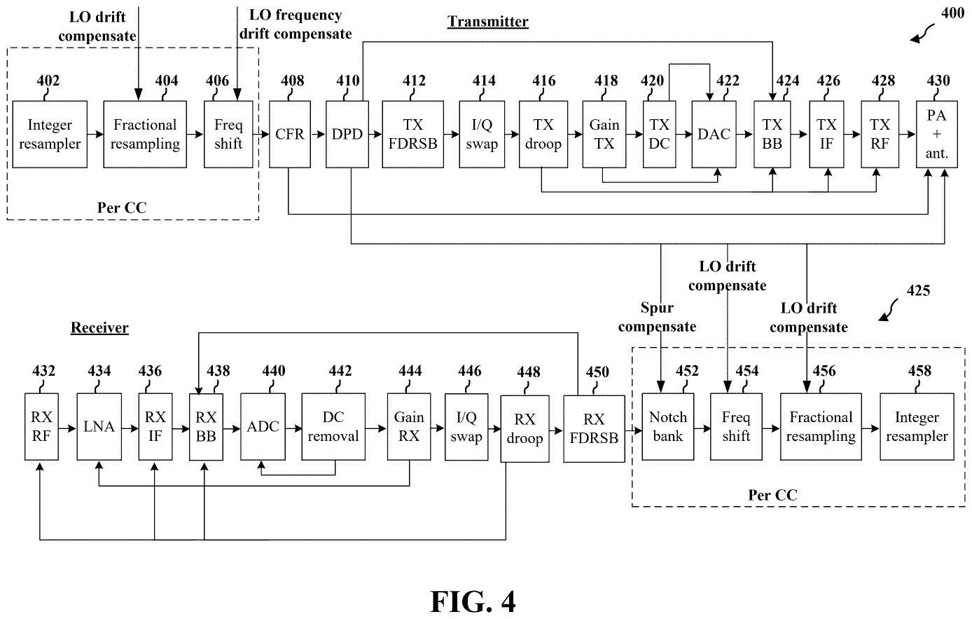

FIG. 4 illustrates example aspects of an RF front end for a transceiver, such as a transceiver of a UE. For transmission via transmission components 400, the RF front end may include an integer resampler component 402 to change a sampling rate by an integer factor, a fractional resampler component 404 to change a sampling frequency, and a frequency shift component 406 that processes the signal for transmission per component carrier (CC). As illustrated aspects of local oscillator (LO) compensation may be applied in connection with the fractional resampling, and LO frequency drift compensation may be applied in connection with the frequency shift component 406. A crest factor reduction (CFR) component 408 may be configured to reduce the peak to average power ratio (PAPR) of a waveform to a desired value. A digital pre-distortion (DPD) component 410 may process the signal to enable improved power amplification (PA). A frequency dependent residual side band correction (FDRSB) component 412 may enable correction or filtering of sidebands. An in-phase and quadrature (I/Q) swap component 414 enables a phase rotation of the signal to be transmitted. A TX droop component 416 may help address a gradual decline in the transmitted signal power over time during a pulse. A gain TX component 418 may help to apply gain of amplification to the signal to be transmitted. The TX direct current (DC) component 420 and the gain TX component 418 provide input to the digital to analog converter (DAC) component 422. The signal can then be processed by baseband components, e.g., including the TX baseband (BB) component 424, the TX intermediate frequency (IF) component 426, and TX radio frequency (RF) component 428. The signal is then processed for power amplification and transmitted by the PA and antenna component 430.

For reception via receiver components 425, the RF receiver 432 receives the over the air signal. The low noise amplifier (LNA) component 434 may amplify the RF signal, and the RX IF component 436 may convert the RF frequency to an intermediate frequency. The RX BB component 438 provides a baseband reception processing in correspondence with the processing by the TX BB component 424. The signal is then processed by an analog to digital converter (ADC) component 440, a DC removal component 442, and a gain RX component 444, which may provide input to the LNA component 434. Similar to the transmission processing, the receiver may include an I/Q swap component 446, an RX droop component 448, and an RX FDRSB component 450. For the per CC processing, the receiver may include a notch bank component 452 that applies compensation for spurs, a frequency shift component 454 that compensates for LO drift, a fractional resampling component 456 that applies LO drift compensation, and an integer resampler component 458. In some aspects, the transmission components and the receiver components may be for different devices, e.g., the transmission may be transmitted to a different device that receives and processes the signal.

In some aspects, as described herein, the transmission components and the receiver components may be comprised in the RF front end of a single device, e.g., a single UE. For example, the receiver components may process and receive signals from other devices. In some aspects, transmission via the transmission components 400 of the UE may be received as self-interference at the receiver components 425.

In some aspects, the RF front end may be configured for adaptive radio frequency front end (a-RFFE) that enables a UE to change its operating parameters to improve performance. For example, a-RFFE may adapt the transceiver to the needs of an incoming signal to be received and/or an outgoing signal to be transmitted by the UE. For example, the adaptation may include adjustment of an ADC or DAC bit width, various filtering, and/or error vector magnitude (EVM) relaxation. In some aspects, joint front end and baseband processing may allow for tighter integration of the RF and baseband processes. Such integration may enable a relaxation of front end processes that can be compensated at the baseband level. For example, machine learning or data driven compensations may be applied at the baseband processing to allow for a reduction or relaxation in at least some processing at the RF front end. The air interface may be adjusted to support adaptive RFFE, e.g., using a waveform that supports a-RFFE and/or signaling between a UE and network to support a-RFFE.

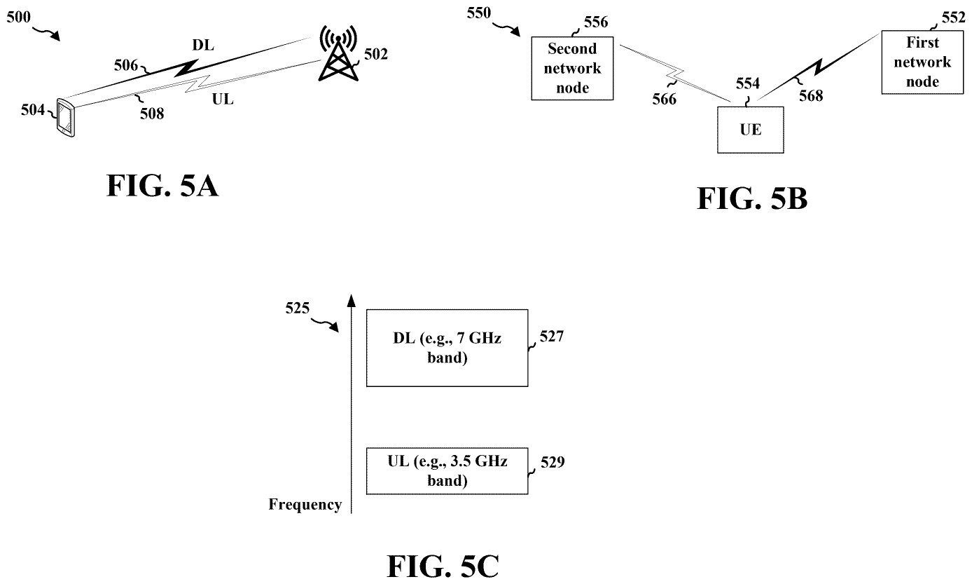

In certain aspects of wireless communication, one or both of a base station and a UE may engage in FDD communication, in which one frequency band is used for uplink communication and a different frequency band is used for downlink communication. Inter-band CA is another example in which wireless communication may be exchanged on different frequency bands. As another example, a UE configured for DC may be served by one RAN node (which may be referred to as a network node) as a primary node and another RAN node as a secondary node. The UE may exchange communication with the RAN nodes using different frequency bands, for example. FIG. 5A is a diagram 500 illustrating a base station 502 (or one or more components of a base station, which may be referred to as a network node) exchanging downlink 506 and uplink 508 communication, with a UE 504. FIG. 5B is a diagram 550 showing an example of DC in which a UE 554 is served by a first network node 552 and a second network node 556. The first network node 552 may transmit downlink communication 566 and the second network node 556 may receive uplink communication 568. As illustrated in the example 525 in FIG. 5C, a network node (e.g., 502, 552, or 556) may transmit downlink communication to the UE 504 or 554 in a first frequency band 527, such as a 7 GHz frequency band. The UE 504 or 554 may transmit uplink communication to a base station (e.g., 502, 552, or 556), whether the same base station or a different base station, in a second frequency band 529, such as a 3.5 GHz frequency band. The example in FIG. 5C is merely one example. In another example, the uplink communication may be in the C band (3.7 to 4.2 GHZ) or a sub-6 frequency band, and the downlink communication may be a frequency band that includes a frequency range within 6-8 GHz. As another example, the transmission may be in FR1, and the reception may be in FR3. FIG. 5C illustrates that the frequency bands 527 and 529 may be separate (e.g., non-overlapping) frequency bands and may be separated by one or more frequency bands. In some aspects, the transmission and reception illustrated in FIG. 5A and/or FIG. 5B may be at least partially overlapping in time.

Even though the downlink reception and the uplink transmission are in different frequency bands, the transmission by the UE 504 or 554 may cause interference (e.g., self-interference) to the UE's reception due to a harmonic frequency. The interference may be referred to as self-interference because the UE's transmission causes the interference to its own reception. In some aspects, the reception may be referred to as simultaneous reception (e.g., overlapping at least partially in time with the UE's transmission in the other frequency band). The inter-band transmission and reception is different than full-duplex operation, which involves transmission and reception in the same frequency band or same TDD carrier, in contrast to the inter-band transmission and reception in different frequency bands. The inter-band self-interference may be significant at the UE, e.g., if flexible TDD scheduling is used for the UE's communication in the two frequency bands.

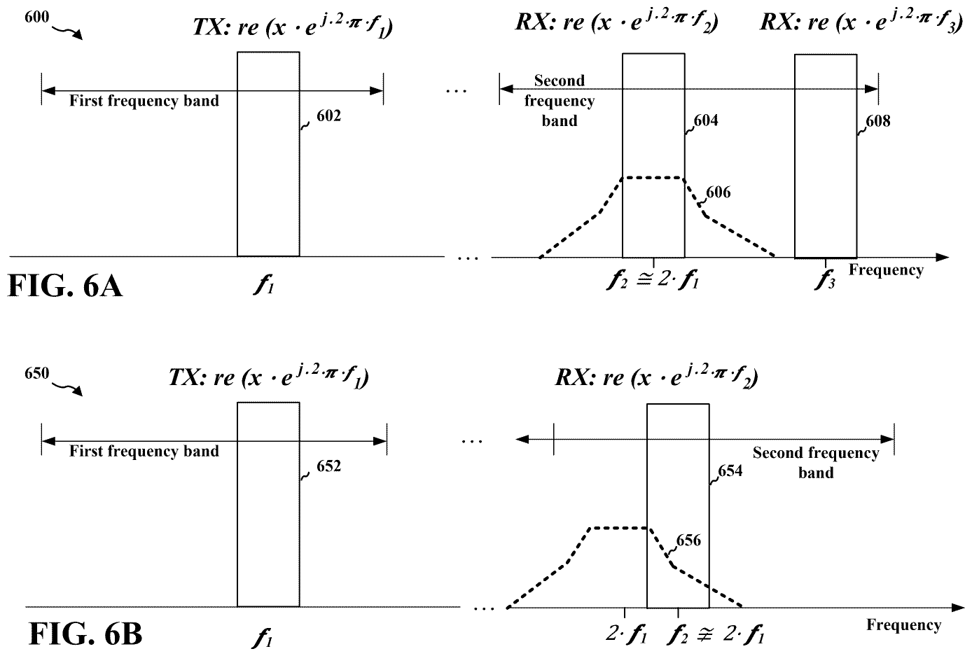

FIG. 6A shows a diagram 600 showing a transmission 602 by the UE at a first frequency (f₁) in a first frequency band. The first frequency (f₁) may be referred to herein as a fundamental frequency, an initial frequency, or a transmission frequency and may be associated with a frequency resource allocated for an UL transmission, which may be referred to as an allocated UL resource, an allocated UL frequency resource, or an impacting and/or interfering UL resource and/or UL frequency resource. FIG. 6A also shows leakage 606 (or interference) that may be experienced at the UE's receiver based on a harmonic frequency (e.g., f₂) of the frequency (f₁) used to transmit the transmission. As shown in FIG. 6A, a second degree, or second order, harmonic frequency is f₂=2*f₁. In the example in which f₁=3.5 GHZ, then the interference will be experienced at f₂=7 GHz. For reception (e.g., of a transmission 608) that is scheduled in the second frequency band, but not overlapping with a (leakage 606, or interference, associated with a) harmonic frequency of the first frequency in the first frequency band at which the UE transmits, the UE may not experience self-interference. If the UE is receiving a transmission 604 in a band at a second frequency that overlaps, at least partially, with the leakage 606 (or interference) due to, or associated with, the harmonic of f₁ (e.g., at f₂), the UE harmonic causes self-interference to the UE's reception, even though the transmission is in a different frequency band than the reception. FIG. 6B illustrates an example 650 in which the UE receives a transmission 654 that may only partially overlap with the leakage 656 due to the UE's transmission 652. There may be different order (or degree) harmonics (or different orders of IMD) that can cause interference to reception at the UE, although the additional order harmonics may have a reduced effect in comparison to the second order harmonic. For example, IMD (e.g., TX IMD) based on the transmission at the frequency f₁ may be represented as:

$$TX IMD = {α}_{2} \cdot {x}_{imd 2} + {α}_{4} \cdot {x}_{imd 4} + … = LPF ( {α}_{2} \cdot {re ( x \cdot {e}^{j \cdot 2 \cdot π \cdot {f}_{1}} )}^{2} + {α}_{4} \cdot {re ( x \cdot {e}^{j \cdot 2 \cdot π \cdot {f}_{1}} )}^{4} + … ) = {α}_{2} \cdot {x}^{2} \cdot {e}^{j \cdot 2 \cdot π \cdot {f}_{2}} + {α}_{4} \cdot {x}^{2} \cdot {\vert x \vert}^{2} \cdot {e}^{j \cdot 2 \cdot π \cdot {f}_{2}} + …$$

The above equation for TX IMD shows two orders of IMD associated with the harmonic frequency (e.g., f₂) of the first frequency f₁. In the equation, αᵢ for i∈(2,4) represents a coefficient associated with the effect of the corresponding order of the IMD (e.g., imd2 and imd4), so that α₂ is for the second order harmonic, α₂ represents the square of the signal at f₁, j is the imaginary number, and LPF indicates a low pass filter. In the equation, imd2 corresponds to the second order IMD and imd4 corresponds to the fourth order IMD. As shown, imd2 and imd4 may both occur on, or have products associated with, the harmonic frequency (f₂).

The interference for communication in the two frequency bands may not be symmetric. For example, the transmission by the UE using frequency resources in the C band may cause self-interference to the UE's reception in a 6-8 GHz band due to a second order (or fourth order) harmonic from the C band. However, a transmission in the 6-8 GHz band may not cause self-interference to the UE's reception in the C band. As presented herein, an RF front end for the UE may take into consideration the potential for the UE to cause a jammer condition (or interference) for its own receiver. As an example, the UE may back off its ADC setpoint and/or AFE setpoint based on an assumption that the transmitter of the UE is transmitting. For example, the ADC setpoint and/or AFE setpoint may be based on an assumed self-interference scenario in which the transmitter at the UE is transmitting. However, using setpoints based on an assumption of self-interference, even in the absence of self-interference, limits the flexible operation of the UE and may add to complexity at the UE.

Aspects presented herein help to alleviate (e.g., avoid or mitigate) inter-band self-interference at the UE in a way that avoids added UE complexity or reduction in UE flexibility. For example, the aspects presented herein help to alleviate intra-UE inter-band self-interference in ways that can be applicable for various types of UEs, including UEs having limited capabilities. The aspects presented herein may help to reduce, avoid, and/or mitigate intra-UE inter-band interference (e.g., self-interference) for FDD operation in different frequency bands, inter-band CA, and/or inter-band DC, among other examples.

As discussed above, in some aspects of FDD operation in different bands, inter-band CA, or inter-band DC where an UL transmission is in a first frequency band (e.g., the C band or a portion of FR1 around 3.5 GHZ, or including a frequency range of 3-4 GHz) and DL is in a second frequency band (e.g., a portion of FR3 centered around 7 GHz, or including a frequency range of 6-8 GHz) for a particular device, self-interference affecting DL reception at a UE may be caused by a transmission of UL data from the UE. For example, transmission at 3 GHz would have a harmonic at 6 GHz. As another example, transmission at 3.5 GHZ, would have a harmonic at 7 GHz. These two examples are merely to illustrate the concept, and the aspects presented herein are applicable for any set of first and second inter-band frequencies, where the frequencies for reception are a harmonic frequency to the frequency used for the transmission. For example, the self-interference may occur on a first set of frequency resources (e.g., RBs or REs) in the second frequency band (e.g., band A) that are associated with frequencies that are two times the frequency (or frequencies) associated with the frequency resources (e.g., RBs or REs) allocated for UL data in the first frequency band (e.g., band B). In some aspects, in addition to the first set of (impacted/effected/interfered with) frequency resources, there may be a second set of frequency resources (e.g., RBs or REs) in the second frequency band (e.g., band A) that are not associated with frequencies that are two times the frequency (or frequencies) associated with the frequency resources (e.g., RBs or REs) allocated for the UL data in the first frequency band (e.g., band B) may experience no, or minimal, interference (e.g., a negligible impact/interference that may be ignored). In some aspects, a particular DL allocation may include frequency resources in the first set of (impacted/effected/interfered with) frequency resources or frequency resources in both the first set of (impacted/affected/interfered with) frequency resources and the second set of (non-impacted/unaffected/minimally impacted) frequency resources in the second frequency band.

While the above discussion focuses on a frequency domain, the first set of (impacted/effected/interfered with) frequency resources may be impacted based on the timing (e.g., during slots and/or symbols) of a (potential) transmission of UL data (e.g., time resources allocated for the UL data). For example, the DL reception is affected by UL transmission that overlaps in time with the DL reception. In some aspects, the DL slots and/or symbols associated with DL reception may not be aligned with UL slots and/or symbols associated with UL transmission and the identification of impacted time-and-frequency resources for DL reception may account for the misalignment between the slots and/or symbols associated with DL reception and UL transmission. Similarly, the first set of (impacted/effected/interfered with) frequency resources may not align with allocable frequency resources and the identification of the impacted frequency may account for the misalignment (e.g., due to a SCS associated with the DL resource allocation and/or the DL reception).

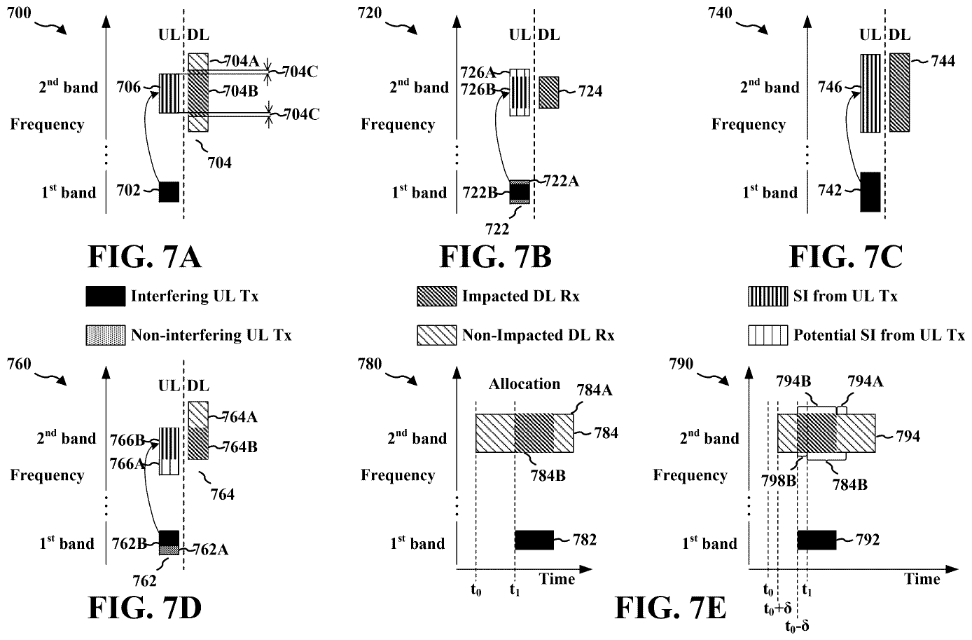

FIG. 7A is a diagram 700 illustrating a first configuration of allocations of UL and DL frequency resources that are fully overlapping from the perspective of the UL frequency resources and partially overlapping from the perspective of the DL frequency resources in accordance with some aspects of the disclosure. In some aspects, an allocation of UL frequency resources 702 (e.g., “N” PRBs) in a first frequency band may correspond to an interference associated with a range of frequencies (e.g., frequency resources 706). An allocation of DL frequency resources 704 (e.g., “M” PRBs) in a second frequency band, in some aspects, may include a first set of DL frequency resources 704B (e.g., a set of “K” impacted PRBs) that experience interference from the allocated UL frequency resources 702, a second set of DL frequency resources 704A that do not experience interference from the allocated UL frequency resources 702, and a third set of DL frequency resources 704C (e.g., guard and/or gap PRBs) that may be impacted, at least in part, by misalignment of frequency resources between the first and second frequency bands. In some aspects, the third set of DL frequency resources 704C may experience different levels (e.g., magnitude or strength) of interference and the interference may be non-uniform across one or more of the first set of DL frequency resources 704B and the third set of DL frequency resources 704C. For example, the first set of DL frequency resources 704B may experience leakage and/or interference associated with a second (or fourth) order, linear, IMD while the third set of DL frequency resources 704C may experience leakage and/or interference associated with a second (or fourth) order, non-linear, IMD that may be weaker than the linear IMD.

In some aspects, a DL rate matching around the first set of DL frequency resources 704B (e.g., avoiding transmissions via the impacted first set of DL frequency resources 704B and, in some aspects, the third set of DL frequency resources 704C, and transmitting DL data via the second set of DL frequency resources 704A) may be implemented. In other aspects, a DL transmission power may be increased for the impacted first set of DL frequency resources 704B and, in some aspects, the third set of DL frequency resources 704C to mitigate the impact of the self-interference caused by the UL transmission associated with the UL frequency resources 702. Additionally, or alternatively, to mitigate the impact of the self-interference caused by the UL transmission associated with the UL frequency resources 702 an MCS may be adjusted (e.g., reduced) for the impacted first set of DL frequency resources 704B and, in some aspects, the third set of DL frequency resources 704C. In some aspects, an UL transmission power may be reduced for UL transmissions via the UL frequency resources 702 to mitigate the impact of the self-interference caused by the UL transmission associated with the UL frequency resources 702.

FIG. 7B is a diagram 720 illustrating a first configuration of allocations of UL and DL frequency resources that are partially overlapping from the perspective of the UL frequency resources and fully overlapping from the perspective of the DL frequency resources in accordance with some aspects of the disclosure. An allocation of DL frequency resources 724 (e.g., “M” PRBs) in a second frequency band may include a set of DL frequency resources. In some aspects, an allocation of UL frequency resources 722 (e.g., “N” PRBs) in a first frequency band may include a first set of UL frequency resources 722B (e.g., a set of “J” impacting and/or interfering PRBs) that cause interference with, or are associated with leakage to, DL reception via the allocated DL frequency resources 724, and a second set of UL frequency resources 722A that do not contribute to, or cause, the interference (e.g., their contribution may be minimal and/or below a threshold magnitude) with the DL reception via the allocated DL frequency resources 724. For example, the interference associated with the UL frequency resources 722 may span a first set of resources 726A that does not correspond to the allocated DL frequency resources 724, and a second set of resources 726B that correspond to the allocated DL frequency resources 724.

In some aspects, a DL rate matching around the allocated DL frequency resources 724 may not be relevant as there are not enough non-impacted DL frequency resources. A DL transmission power, in some aspects, may be increased for the impacted DL frequency resources 724 to mitigate the impact of the self-interference caused by the UL transmission associated with the first set of UL frequency resources 722B. Additionally, or alternatively, to mitigate the impact of the self-interference caused by the UL transmission associated with the first set of UL frequency resources 722B an MCS may be adjusted (e.g., reduced) for the impacted DL frequency resources 724. In some aspects, a UL transmission power may be reduced for UL transmissions via the first set of UL frequency resources 722B to mitigate the impact of the self-interference caused by the UL transmission associated with the first set of UL frequency resources 722B.

FIG. 7C is a diagram 740 illustrating a first configuration of allocations of UL and DL frequency resources that are fully overlapping from the perspective of the UL frequency resources and fully overlapping from the perspective of the DL frequency resources in accordance with some aspects of the disclosure. An allocation of DL frequency resources 744 (e.g., “M” PRBs) in a second frequency band may include a set of DL frequency resources. In some aspects, an allocation of UL frequency resources 742 (e.g., “N” PRBs) in a first frequency band may include a set of UL frequency resources that cause interference with, or are associated with leakage to, DL reception via the allocated DL frequency resources 744 (e.g., via harmonic frequency resources 746).

In some aspects, a DL rate matching around the allocated DL frequency resources 744 may not be relevant as there are not enough non-impacted DL frequency resources. A DL transmission power, in some aspects, may be increased for the impacted DL frequency resources 744 to mitigate the impact of the self-interference caused by the UL transmission associated with the UL frequency resources 742. Additionally, or alternatively, to mitigate the impact of the self-interference caused by the UL transmission associated with the UL frequency resources 742 an MCS may be adjusted (e.g., reduced) for the impacted DL frequency resources 744. In some aspects, a UL transmission power may be reduced for UL transmissions via the UL frequency resources 742 to mitigate the impact of the self-interference caused by the UL transmission associated with the UL frequency resources 742.

FIG. 7D is a diagram 760 illustrating a first configuration of allocations of UL and DL frequency resources that are partially overlapping from the perspective of the UL frequency resources and partially overlapping from the perspective of the DL frequency resources in accordance with some aspects of the disclosure. An allocation of DL frequency resources 764 (e.g., “M” PRBs) in a second frequency band may include a first set of DL frequency resources 764B (e.g., a set of “K” impacted PRBs) that experience interference from a first set of UL frequency resources 762B (corresponding to harmonic frequency resources 766A) and a second set of DL frequency resources 764A that do not experience interference from the first set of UL frequency resources 762B. In some aspects, an allocation of UL frequency resources 762 (e.g., “N” PRBs) in a first frequency band may include a first set of UL frequency resources 762B (e.g., a set of “J” impacting and/or interfering PRBs corresponding to harmonic frequency resources 766B) that cause interference with, or are associated with leakage to, DL reception via the first set of DL frequency resources 764B, and a second set of UL frequency resources 762A (corresponding to harmonic frequency resources 766A) that do not contribute to, or cause, the interference (e.g., their contribution may be minimal and/or below a threshold magnitude) with the DL reception via the second set of DL frequency resources 764A.

In some aspects, a DL rate matching around the first set of DL frequency resources 764B (e.g., avoiding transmissions via the impacted first set of DL frequency resources 764B and transmitting DL data via the second set of DL frequency resources 764A) may be implemented. A DL transmission power, in some aspects, may be increased for the impacted first set of DL frequency resources 764B to mitigate the impact of the self-interference caused by the UL transmission associated with the first set of UL frequency resources 762B. Additionally, or alternatively, to mitigate the impact of the self-interference caused by the UL transmission associated with the first set of UL frequency resources 762B an MCS may be adjusted (e.g., reduced) for the impacted first set of DL frequency resources 764B. In some aspects, a UL transmission power may be reduced for UL transmissions via the first set of UL frequency resources 762B to mitigate the impact of the self-interference caused by the UL transmission associated with the first set of UL frequency resources 762B.

FIG. 7E is a set of diagrams (e.g., diagram 780 and diagram 790) illustrating an example interference associated with allocated time-and-frequency resources for UL in a first band and DL in a second band in accordance with some aspects of the disclosure. An allocation of DL resources 784 (e.g., “M” PRBs) in a second frequency band and over a first time span (e.g., a set of slots) may include a first set of DL resources 784B (e.g., a set of “K” impacted PRBs in a set of “H” slots) that may experience interference from allocated UL resources 782 and at least a second set of DL resources 784A that may not experience interference from the allocated UL resources 782. In some aspects, an allocation of UL resources 782 (e.g., “N” PRBs) in a first frequency band may cause interference with, or may be associated with leakage to, DL reception via the first set of DL resources 784B.

Diagram 790 illustrates that, while the allocated UL and DL resources may overlap in the set of time-and-frequency resources identified by, or associated with, the set of DL resources 784B, when the UL transmission and DL reception are performed the interference occurs in a third set of DL resources 794B. The misalignment in time between the UL resources 792 and the DL resources 794 associated with a same time at, e.g., a base station receiving the UL transmission and transmitting the DL transmission, in some aspects, may be introduced by a timing advance and/or propagation delay (δ). In some aspects, the impacted third set of DL resources 794B may partially overlap with the first set of DL resources 784B and include a fourth set of impacted DL resources 798B that, in the absence of the misalignment, would not have been impacted. Similarly, a fifth set of DL resources 794A that, in the absence of the misalignment, would have been impacted, may not be impacted based on the misalignment in time. In some aspects, the misalignment in time may be compensated for by a set of gap and/or guard times (e.g., symbols, slots, etc.) when performing self-interference avoidance and/or mitigation.

One of the UL transmission or the DL transmission (and the associated UL reception and DL reception) may be adjusted, in some aspects, to avoid and/or mitigate the impact of the UL transmission on the first set of frequency resources. For example, a base station may be configured to perform a DL rate matching (e.g., transmit DL data via allocated DL resources in the second set of frequency resources, or around the impacted resources), increase a DL transmission power for the DL transmission associated with the allocated DL resources in the first set of frequency resources, or reduce (or lower) an MCS for the DL transmission associated with the allocated DL resources in the first set of frequency resources. In some aspects, a UE may be configured to reduce an UL transmission power for the UL transmission associated with (e.g., impacting and/or interfering with) the allocated DL resources in the first set of frequency resources.

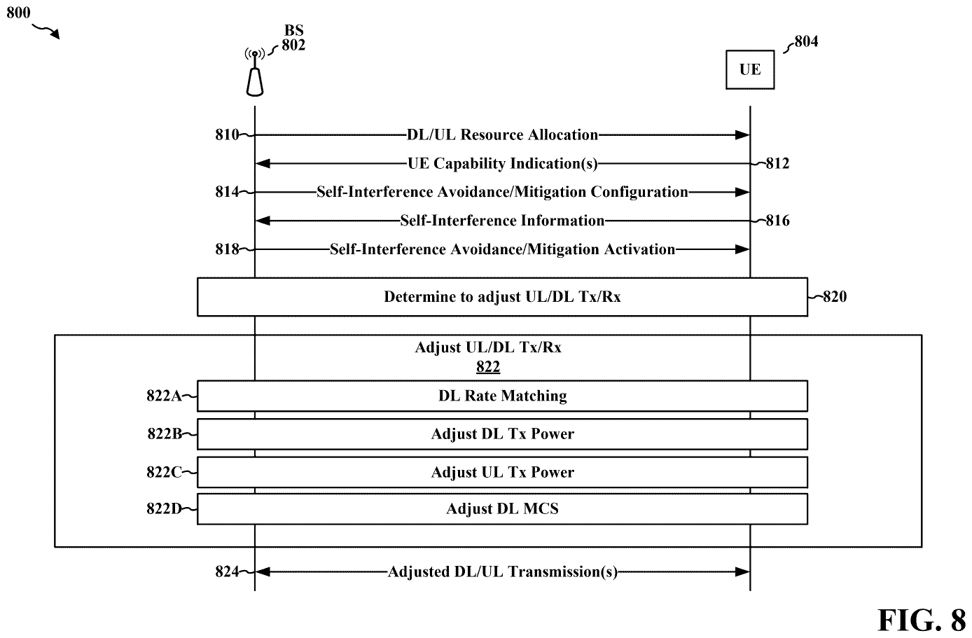

FIG. 8 is a call flow diagram 800 illustrating a method of wireless communication in accordance with some aspects of the disclosure. The method is illustrated in relation to a base station 802 (e.g., as an example of a network device or network node that may include one or more components of a disaggregated base station) in communication with a UE 804 (e.g., as an example of a wireless device). The functions ascribed to the base station 802, in some aspects, may be performed by one or more components of a network entity, a network node, or a network device (a single network entity/node/device or a disaggregated network entity/node/device as described above in relation to FIG. 1). Similarly, the functions ascribed to the UE 804, in some aspects, may be performed by one or more components of a wireless device supporting communication with a network entity/node/device. Accordingly, references to “transmitting” in the description below may be understood to refer to a first component of the base station 802 (or the UE 804) outputting (or providing) an indication of the content of the transmission to be transmitted by a different component of the base station 802 (or the UE 804). Similarly, references to “receiving” in the description below may be understood to refer to a first component of the base station 802 (or the UE 804) receiving a transmitted signal and outputting (or providing) the received signal (or information based on the received signal) to a different component of the base station 802 (or the UE 804).

The base station 802 may transmit, and the UE 804 may receive, a resource allocation 810. In some aspects, the resource allocation 810 may include a first allocation (e.g., via a first MAC-CE or DCI) of UL resources spanning a first range of frequencies (e.g., f₁) within a first frequency band and a second allocation (e.g., via a second MAC-CE or DCI) of DL resources spanning a second range of frequencies within a second frequency band that includes a harmonic (f₂~2*f₁) of the frequency of the UL transmission (e.g., where the allocated DL resources includes DL resources in the second set of frequency resources or second frequency band). In some aspects, the DL resources may include at least one harmonic frequency resource that is harmonic to the UL resources as described in relation to at least FIGS. 6A, 6B, 7A, 7B, 7C, 7D, and 7E. The allocated UL resources, in some aspects, may comprise “N” PRBs and the allocated DL resources may include “M” PRBs. The at least one harmonic frequency resource, in some aspects, may include a first set of “K” PRBs of the allocated DL resources that may be impacted by “J” PRBs of the allocated UL resources in the first range of frequencies, e.g., by linear, and/or non-linear, intermodulation distortion (IMD) associated with the first range of frequencies spanned by the “N” PRBs of the allocated UL resources. In some aspects, the “J” PRBs of the allocated UL resources may be referred to as “impacting” resources and the “K” PRBs of the allocated DL resources may be referred to as “impacted” resources. The allocated DL and UL resources, in some aspects, may include additional non-impacted, or non-impacting, resources (or frequency resources).

In some aspects, the first frequency band may be FR1, a portion of FR1 (e.g., 3-4 GHz), or the C band, and the second frequency band may be at least part of a 6-8 GHz frequency range, or FR3, and the DL resources at least partially overlap with the at least one harmonic frequency resource to the UL resources. The UL resources and the DL resources, in some aspects, may be associated with one of inter-band carrier aggregation or inter-band dual connectivity, and the at least one harmonic frequency resource may be a second harmonic of at least one frequency included in the first range of frequencies corresponding to the at least one harmonic frequency resource, and a UL transmission associated with the at least one frequency included in the first range of frequencies may be a source of self-interference associated with a reception of a DL transmission at the UE. As discussed in relation to FIGS. 7B and 7C, the allocated DL resources may fully overlap with the at least one harmonic frequency resource, e.g., may only include (or be allocated from) frequency resources in the first set of (impacted/effected/interfered with) frequency resources. The allocated DL resources, in some aspects, may partially overlap with the at least one harmonic frequency resource, e.g., may also include (or be allocated from) frequency resources in the second set of (non-impacted/unaffected/minimally impacted) frequency resources (e.g., as illustrated in FIGS. 7A and 7D). A partial overlap (from the perspective of DL resources), in some aspects, may be associated with self-interference avoidance and/or mitigation for the DL transmission, while a full overlap may be associated with self-interference mitigation for the DL transmission. Similarly, partial overlap (from the perspective of UL resources), in some aspects, may be associated with self-interference avoidance and/or mitigation for the UL transmission, while a full overlap may be associated with self-interference mitigation for the UL transmission.

The UE 804 may transmit, and the base station 802 may receive, a UE capability indication 812, indicating one or more of whether the UE supports self-interference avoidance for DL resources in the first set of (impacted/effected/interfered with) frequency resources (e.g., self-interference avoidance for an inter-band CA mode on the impacted downlink PRBs based on DL rate matching, whether the UE supports self-interference mitigation based on adjusting (e.g., increasing) DL transmission power, whether the UE supports self-interference mitigation based on adjusting (e.g., decreasing) UL transmission power, or whether the UE supports self-interference mitigation based on adjusting (e.g., decreasing) an MCS for the DL transmission. While illustrated as a single UE capability indication 812, in some aspects, each capability may be indicated in a separate capability indication. In aspects not transmitting the UE capability indication 812, the base station 802 may perform the DL rate matching based on knowledge of the allocated DL and UL resources and indicate the characteristics of the DL rate matching to the UE 804. The UE capability indication 812, in some aspects, may include (or indicate) an identification of impacted DL resources (DL resources affected by self-interference) and/or a magnitude associated with the impact on one or more of the impacted DL resources. In some aspects, the identification of the impacted DL resources may be based on one or more threshold values such that multiple sets of impacted DL resources may be identified and associated with a corresponding magnitude (or degree) of impact. In some aspects, the impact information may be transmitted independently of the UE capability indication 812.

The base station 802 may transmit, and the UE 804 may receive, a self-interference avoidance/mitigation configuration 814. The self-interference avoidance/mitigation configuration 814, in some aspects, may indicate that the UE 804 should assume DL rate matching around the PRBs for DL reception impacted by the allocated UL resources based on the known DL and UL resource allocations (e.g., based on resource allocation 810 or known reference signal configurations). In some aspects, the self-interference avoidance/mitigation configuration 814 may indicate one or more criteria for DL rate matching. In some aspects, the one or more criteria may be based on (1) receiving an of DL rate matching (e.g., self-interference avoidance/mitigation activation 818 discussed below), (2) an MCS value (or index), (3) an UL transmission power level, or (4) an interference between allocated UL resources and allocated DL resources. For example, a threshold MCS value (or index value) associated with the DL resources, or a threshold UL transmission power, may be used to determine whether DL rate matching is performed by the base station 802 (and expected and/or anticipated by the UE 804). The threshold MCS value may be one of a maximum MCS value (or index), or a minimum MCS value (or index), for which DL rate matching is performed. Similarly, the threshold UL transmission power may be a maximum UL transmission power for which DL rate matching is not performed (e.g., DL rate matching is performed when UL transmission power exceeds the indicated maximum UL transmission power). In some aspects, the self-interference avoidance/mitigation configuration 814 may indicate the threshold value(s) directly, by reference to a set of known values, or the threshold value(s) may be known (or pre-configured).

The self-interference avoidance/mitigation configuration 814, in some aspects, may include (or indicate) one or more DL transmission powers and/or or power offsets associated with the non-impacted DL resources and/or the impacted DL resources in the allocated DL resources. For example, a (base) DL transmission power may be indicated for non-impacted DL resources and a DL transmission power offset may be indicated for impacted DL resources, so that the DL transmission power associated with the impacted DL resources may be calculated as the (base) DL transmission power plus the offset. In some aspects, the self-interference avoidance/mitigation configuration 814 may include (or indicate) one or more configured values, or a range of configured values, for an UL transmission power reduction associated with impacting UL resources (e.g., allocated UL resources for which harmonic frequencies (or harmonics), at least potentially, impact allocated DL resources). The self-interference avoidance/mitigation configuration 814, in some aspects associated with reducing the UL transmission power, may include (or indicate) an additional P_{c,max} associated with the impacting UL resources for power reduction and the UE may report its power headroom based on the additional P_{c,max}.

The self-interference avoidance/mitigation configuration 814, in some aspects, may include (or indicate) a timing value (or threshold timing value) associated with applying an UL transmission power reduction in association with dynamically scheduled DL transmissions. In some aspects, the timing value may be associated with, or based on, a time between decoding an indication of the dynamically scheduled DL transmissions (e.g., a DCI scheduling the DL transmission) and a transmission of an UL transmission associated with self-interference with the reception of the dynamically scheduled DL transmission. For example, if a DCI is scheduled within a same slot (e.g., K0=0) or for reception at a time that is less that the timing value in the future, the UE may not be expected to reduce the UL transmission power of the remaining portion of the UL transmission. In some aspects, this may be based on a portion of an UL transmission (e.g., an impacting or self-interfering UL transmission) already having started by the time the DCI is decoded. In some aspects, the self-interference avoidance/mitigation configuration 814, may include (or indicate) criteria for applying an UL transmission power reduction, where the criteria may be related to one or more of a channel priority or quality of service (QoS) characteristic associated with the data transmitted via the allocated UL and DL resources (e.g., a relative priority of the UL data and the DL data).

In some aspects, the self-interference avoidance/mitigation configuration 814 may indicate one or more MCS values (or indexes) associated with different sets of RBs. As the impact of the impacting UL resources may change across the impacted resources, the self-interference avoidance/mitigation configuration 814 may indicate a different MCS value (or index) for different DL resources (RBs or frequency resources) based on the amount of impact on the different DL resources. In some aspects, self-interference avoidance/mitigation configuration may be pre-configured or known in the absence of the transmission and/or receipt of the self-interference avoidance/mitigation configuration 814.

The UE 804, may transmit, and the base station 802, may receive, self-interference information 816. The self-interference information 816, in some aspects, may include (or indicate) an identification of impacted DL resources (DL resources affected by self-interference) and/or a magnitude associated with the impact on one or more of the impacted DL resources. In some aspects, the identification of the impacted DL resources may be based on one or more threshold values such that multiple sets of impacted DL resources may be identified and associated with a corresponding magnitude (or degree) of impact. In some aspects, the self-interference information 816 may be transmitted and/or received (e.g., in the UE capability indication 812) before receiving the self-interference avoidance/mitigation configuration 814, and may be used to determine the content of the self-interference avoidance/mitigation configuration 814 (e.g., the identified set of “K” PRBs of the allocated DL resources that may be impacted by “J” PRBs of the allocated UL resources and/or the different MCS value for different DL resources based on the amount of impact on the different DL resources). The self-interference information 816, in some aspects, may include information relating to a timing advance (TA) associated with the UL transmissions and or information relating to a frequency offset and/or misalignment between UL frequency resources and DL frequency resources in the first and second frequency bands (e.g., a misalignment that may affect the identification of the impacted PRBs). In some aspects, the self-interference information 816, in some aspects, may include (or indicate) scheduled UL resources within the allocated UL resources, and the base station may use the information to determine whether to perform a self-interference avoidance and/or mitigation (e.g., employ or implement one or more self-interference avoidance and/or mitigation methods) and to determine and/or identify the DL resources associated with a DL rate matching, an increased DL transmission power, and/or a reduced MCS value (or index).

In some aspects, the base station 802 may transmit, and the UE 804 may receive, a self-interference avoidance/mitigation activation 818 indicating a method of self-interference avoidance and/or mitigation to be employed by the base station 802, or for the UE 804 to employ, in association with a subsequent DL reception and/or UL transmission. The indication, in some aspects, may include one or more characteristics of the method of self-interference avoidance and/or mitigation (e.g., a DL transmission power for impacted and/or non-impacted DL resources, an UL transmission power for impacting and/or non-impacting UL resources, one or more MCS for one or more subsets of the DL resources, or an indication of impacted DL resources associated with a DL rate matching). The self-interference avoidance/mitigation activation 818, in some aspects, may be included in a DCI (e.g., a field or bit in the DCI) scheduling one of an UL transmission or DL reception at the UE 804. For DL semi-persistent scheduling, or semi-persistently scheduled, (SPS) PDSCH, the self-interference avoidance/mitigation activation 818 may be included in RRC signaling. In some aspects, the self-interference avoidance/mitigation activation 818 may be omitted, e.g., if the use of the self-interference avoidance and/or mitigation method is based on triggering conditions (e.g., rules and/or criteria that are known, pre-configured, or indicated in the self-interference avoidance/mitigation configuration 814).

Based on one or more of the resource allocation 810, the UE capability indication 812, the self-interference avoidance/mitigation configuration 814, the self-interference information 816, or the self-interference avoidance/mitigation activation 818, the base station 802 and the UE 804 may determine to implement and/or employ a self-interference avoidance and/or mitigation method as discussed above. For example, at 820, the base station 802 may determine to perform an adjustment to a DL transmission and/or an UL reception and/or the UE 804 may determine to perform a corresponding adjustment to a DL reception and/or an UL transmission. In some aspects, the determination at the base station 802 may occur before the transmission of the self-interference avoidance/mitigation activation 818, while the determination at the UE 804 occurs after (and is based on) the reception of the self-interference avoidance/mitigation activation 818.

After determining to perform the adjustment at 820, the base station 802 may, at 822, adjust a DL transmission and/or an UL reception with the UE 804 performing a corresponding adjustment to a DL reception and/or an UL transmission. The adjustment at 822, in some aspects, is made to, or may result in, adjusted DL/UL transmission(s) 824 exchanged between the base station 802 and the UE 804. For example, adjusted DL/UL transmission(s) 824 may include an adjusted DL transmission that is transmitted by the base station 802 and received by the UE 804. Additionally, or alternatively, the adjusted DL/UL transmission(s) 824 may include an adjusted UL transmission that is transmitted by the UE 804 and received by the base station 802.

In some aspects, at 822A, the base station 802 may perform DL rate matching around the impacted DL resources (e.g., the first set of (impacted/effected/interfered with) frequency resources or first set of “K” PRBs of the allocated DL resources that may be impacted by “J” PRBs of the allocated UL resources) and the UE 804 may perform a corresponding adjustment to a decoding of the rate-matched DL transmission. As discussed above, the DL rate matching may be based on the resource allocation 810, the UE capability indication 812, the self-interference avoidance/mitigation configuration 814, and/or the self-interference information 816 used to identify the DL resources around which to perform the rate-matching (e.g., the first set of (impacted/effected/interfered with) frequency resources or first set of “K” PRBs of the allocated DL resources that may be impacted by “J” PRBs of the allocated UL resources). The DL rate matching, in some aspects, may be a self-interference avoidance method.

In some aspects, the DL rate matching may account for allocated UL resources (e.g., REs) associated with one or more reference signals, such as DM-RS or SRS. A symbol carrying DM-RS (or other RS), in some aspects, may use a comb pattern with REs not transmitting (or including) the DM-RS being left empty (or omitting UL data transmissions) such that DL reception at corresponding frequencies may not be impacted by the omitted UL data transmissions. For example, a comb-N centered around a first frequency in the allocated UL resources (e.g., f₁) may be mapped to (or impact) a comb-P (where P may be equal to N/2) centered around a second, harmonic, frequency (e.g., f₂=2*f₁) and the (implicit) DL rate matching may use the known pattern to avoid the impacted/affected REs. The pattern could be a function of UE's PA characteristics (e.g., the amount of non-linear IMD leakage, or interference, around the linear IMD at the second, harmonic, frequency) which may be indicated by the UE 804 to the base station 802 (e.g., via the self-interference information 816).

In some aspects, the DL symbol reception time (e.g., a timing associated with a DL reception in a first symbol of the allocated DL resources) in the second frequency band and the UL symbol transmission time (e.g., a timing associated with an UL transmission in a first symbol of the allocated UL resources) in the first frequency band may not be aligned due to propagation delay (e.g., where the propagation delay may be associated with a timing advance (TA) value). Additionally, or alternatively, a SCS for the allocated DL resources and the SCS for the allocated UL resources may be different, and the slot and/or PRB boundaries may not be aligned in the first and second frequency bands. Thus, the identification of “impacted” DL resources may account for the lack of alignment (or the misalignment) in one or more of time and frequency. Accordingly, the DL rate matching performed at 822A may be associated with additional symbols and/or subcarriers around DL (time-and-frequency) resources identified without considering the lack of alignment (or the misalignment) of the timing and/or frequencies associated with the UL transmissions via the first frequency band and the DL reception via the second frequency band. In some aspects, the lack of alignment (in one or more of time and/or frequency) may be indicated by the UE to the base station (e.g., via the self-interference information 816) and may be accounted for by an indication from the base station to the UE (e.g., via the self-interference avoidance/mitigation configuration 814) of a first number of gap/guard symbols and/or a second number of gap/guard subcarriers around the DL (time-and-frequency) resources identified without considering the lack of alignment. The first number of gap/guard symbols and/or a second number of gap/guard subcarriers around the DL (time-and-frequency) resources identified without considering the lack of alignment, in some aspects, may be known, or pre-configured (e.g., based on a worst-case assumption).

In additional to, or in place of, the self-interference avoidance associated with DL rate matching, the base station 802 and the UE 804 may perform self-interference mitigation at 822B, 822C, or 822D. For example, at 822B, the base station 802, in some aspects may adjust a DL transmission power of one or more DL resources of the allocated DL resources and the UE 804 may perform a corresponding adjustment to a decoding of the adjusted DL transmission. For example, allocated DL resources may include “M” PRBs in the second frequency band and allocated UL resources may include “N” PRBs in the first frequency band. The “M” PRBs, in some aspects, may include “K” PRBs (where the “K” PRBs may be up to “M” PRBs) that are impacted by, or in-band with, “J” PRBs of the “N” PRBs included in the allocated UL resources in the first frequency band (where the “J” PRBs may be up to “N” PRBs). To mitigate the self-interference at the “K” PRBs caused by 2^{nd} harmonics, the base station 802 may, at 822B, boost (e.g., increase) a DL transmission power by “T1” dB on the in-band “K” PRBs for downlink reception. In some aspects, the “K” PRBs may not include all of the “M” PRBs and the base station 802 may transmit DL data with different DL Tx powers on the “K” PRBs and the remaining PRBs of the “M” PRBs allocated for DL transmissions (e.g., different DL transmission powers for impacted PRBs and non-impacted PRBs). For PDSCH reception at the UE, the energy per RE (EPRE) may be different for the (“J”) impacted PRBs and the non-impacted PRBs. As described above, the value “T1” or a related value, may be indicated to the UE by the base station (e.g., via the self-interference avoidance/mitigation configuration 814).

In some aspects, at 822C, the UE 804, may adjust (or reduce) a UL transmission power of one or more UL resources of the allocated UL resources and the base station 802 may receive the adjusted UL transmission and perform a corresponding adjustment to a decoding of the adjusted UL transmission. For example, allocated DL resources may include “M” PRBs in the second frequency band and allocated UL resources may include “N” PRBs in the first frequency band. The “M” PRBs, in some aspects, may include “K” PRBs (where the “K” PRBs may be up to “M” PRBs) that are impacted by, or in-band with, “J” PRBs of the “N” PRBs included in the allocated UL resources in the first frequency band (where the “J” PRBs may be up to “N” PRBs). To mitigate the self-interference at the “K” PRBs caused by 2^{nd} harmonics of the “J” PRBs, the UE 804 may, at 822C, lower (e.g., reduce) an UL transmission power by “T2” dB on the impacting “J” PRBs of the UL transmission. In some aspects, the “J” PRBs may not include all of the “N” PRBs and the UE 804 may transmit UL data with different UL Tx powers on the “J” PRBs and the remaining PRBs of the “N” PRBs allocated for UL transmissions (e.g., different UL transmission powers for impacting PRBs and non-impacting PRBs).

In some aspects, a same total power per symbol may be maintained (e.g., a power per symbol associated with the UL transmission without the reduced UL transmission power over the “J” PRBs may be maintained when reducing the UL transmission power over the “J” PRBs). To maintain the same total power per symbols, in some aspects, impacting REs and non-impacting REs may be associated with different EPREs. For example, the EPRE, and associated UL transmission power, may be increased for the non-impacting REs to compensate for the reduced UL transmission power, and associated EPRE, associated with the impacting “J” PRBs and, to adjust the UL transmission power, the UE 804 may decrease or reduce the UL transmission power associated with the “J” impacting PRBs while increasing the UL transmission power associated with the remaining non-impacting PRBs. As described above, the value “T2” or a set of configured values from which “T2” may be selected, may be indicated to the UE by the base station (e.g., via the self-interference avoidance/mitigation configuration 814). In some aspects, a determination (e.g., at 820) to lower the power (e.g., reduce the UL transmission power) or to select a new P_{c,max} may be based on the channel priority and/or a QoS associated with the UL data and/or the DL data, or may be explicitly signaled by the base station 802 (e.g., by a dynamic grant, such as the self-interference avoidance/mitigation activation 818). In some aspects, a separate P′_{c,max} for power reduction (where P′_{c,max} for the impacting “J” PRBs may be less than P_{c,max} for the non-impacting PRBs) may be defined on, or for, the UL transmit power control, and the UE may report its power headroom based on this power reduction (e.g., based on the separate P′_{c,max} for power reduction).

As discussed above, the UE 804, in some aspects, may not adjust the UL transmission power reduction if an impacted DL reception (e.g., a DL reception included DL resources impacted by an UL transmission) is dynamically scheduled (e.g., scheduled by a same slot scheduling with K0=0). In some aspects, before the DL DCI is decoded, the UE may already have transmitted some of the UL data. The adjustment at 822C of the UL transmission power, in some aspects, may be applied for semi-static, SPS, or periodic DL resources, or when K0 is greater than 0 or a (newly) defined threshold for dynamically scheduled PDSCH (e.g., the timing value, or threshold timing value, that may be included in the self-interference avoidance/mitigation configuration 814). Otherwise, UE is not required to reduce the Tx power. In some aspects, the UE may not adjust, and/or may not be expected to adjust, the UL transmission power for UL resources impacting a dynamically scheduled DL reception based on the defined threshold for dynamically scheduled PDSCH.

In some aspects, at 822D, the base station 802, in some aspects may adjust an MCS (e.g., an MCS index or MCS value) of one or more DL resources of the allocated DL resources. For example, allocated DL resources may include “M” PRBs in the second frequency band and allocated UL resources may include “N” PRBs in the first frequency band. The “M” PRBs, in some aspects, may include “K” PRBs (where the “K” PRBs may be up to “M” PRBs) that are impacted by, or in-band with, “J” PRBs of the “N” PRBs included in the allocated UL resources in the first frequency band. To mitigate the self-interference at the “K” PRBs caused by 2^{nd} harmonics, the base station 802 may, at 822D, lower (e.g., reduce) an MCS on the in-band “K” PRBs for downlink reception. In some aspects, the “K” PRBs may not include all of the “M” PRBs and the base station 802 may transmit DL data with different MCS on the “K” PRBs and the remaining PRBs of the “M” PRBs allocated for DL transmissions (e.g., different DL transmission powers for impacted PRBs and non-impacted PRBs). In some aspects, different subsets of the “M” PRBs may experience different levels (or magnitudes) of self-interference (e.g., due to non-uniform IMD interference or leakage which may be based on different orders, or degrees, of IMD) and more than two different MCS may be used for the different subsets of the “M” PRBs.

As described above, adjusted DL/UL transmission(s) 824 may be exchanged between the base station 802 and the UE 804 based on one or more of the adjustments described above in relation to the adjustment(s) to the DL transmission/reception and/or the UL reception/transmission performed at 822. For example, adjusted DL/UL transmission(s) 824 may include an adjusted DL transmission that is transmitted by the base station 802 and received by the UE 804. Additionally, or alternatively, the adjusted DL/UL transmission(s) 824 may include an adjusted UL transmission that is transmitted by the UE 804 and received by the base station 802.

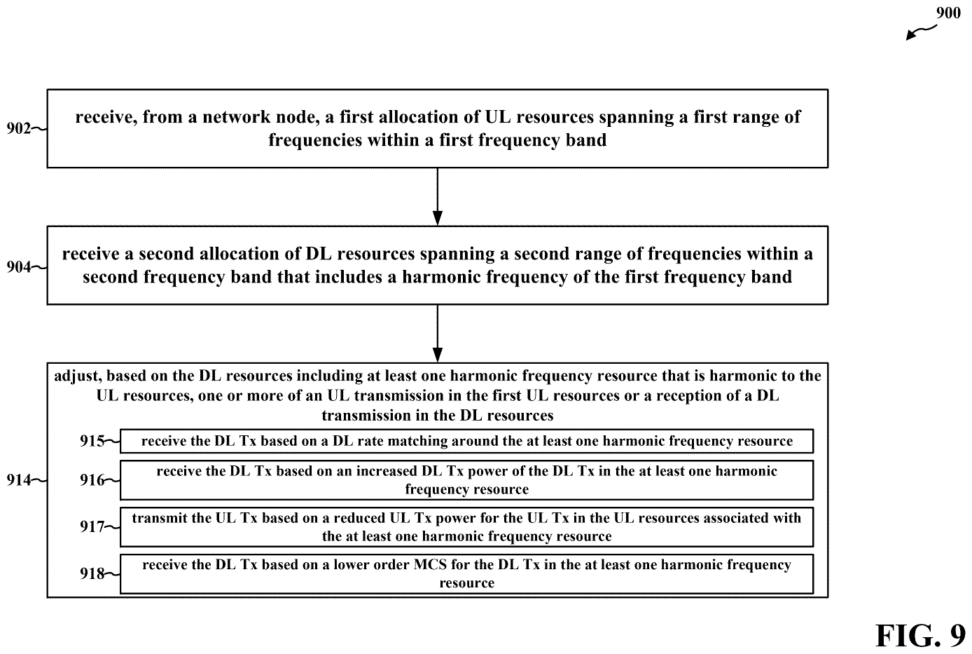

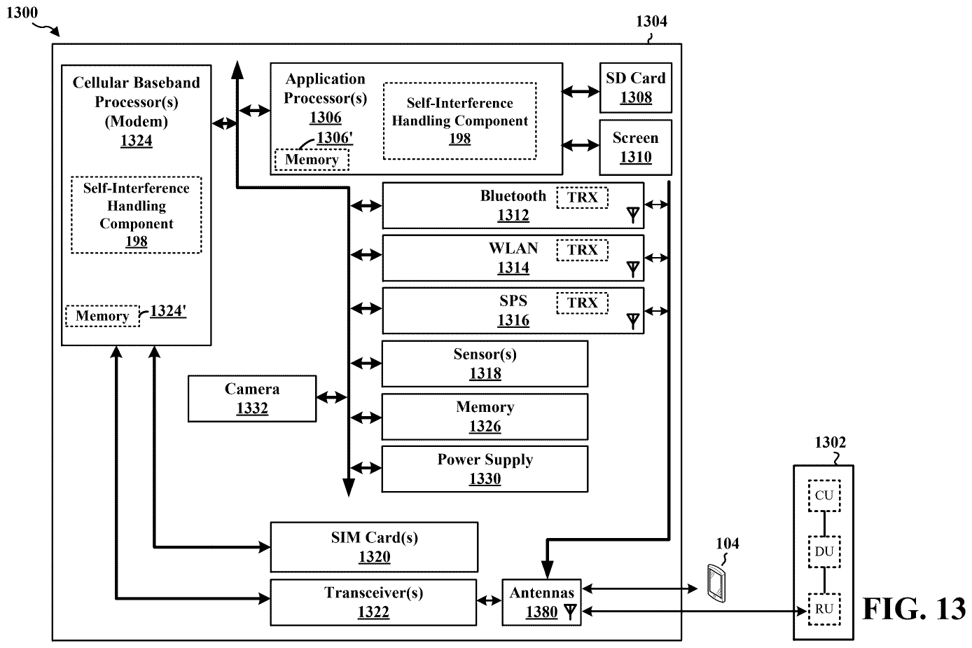

FIG. 9 is a flowchart 900 of a method of wireless communication. The method may be performed by a wireless device such as a UE (e.g., the UE 104, 504, 804; the apparatus 1304). At 902, the UE may receive, from a network node, a first allocation of UL resources spanning a first range of frequencies within a first frequency band. For example, 902 may be performed by application processor(s) 1306, cellular baseband processor(s) 1324, transceiver(s) 1322, antenna(s) 1380, and/or self-interference handling component 198 of FIG. 13. In some aspects, the first frequency band may include at least a portion of FR1 or a C band (e.g., a frequency band centered around 3.5 GHZ, such as 3-4 GHz or 3.25-3.75 GHZ). For example, referring to FIG. 8, the UE 804 may receive resource allocation 810 including, or indicating/allocating, “N” PRBs in a first frequency band.

At 904, the UE may receive, from the network node, a second allocation of DL resources spanning a second range of frequencies within a second frequency band that includes a harmonic of the first frequency band. For example, 904 may be performed by application processor(s) 1306, cellular baseband processor(s) 1324, transceiver(s) 1322, antenna(s) 1380, and/or self-interference handling component 198 of FIG. 13. In some aspects, the UL resources and the DL resources may be associated with one of inter-band carrier aggregation or inter-band dual connectivity. In some aspects, the second frequency band may include at least part of a 6-8 GHz frequency range of FR3, and the allocated DL resources at least partially overlap with (or include) the at least one harmonic frequency resource (e.g., a resource that is associated with a frequency that is twice that of at least one UL resource). The at least one harmonic frequency resource may be a second harmonic of at least one frequency included in the first range of frequencies corresponding to the at least one harmonic frequency resource, and an UL transmission associated with the at least one frequency included in the first range of frequencies may be a source of self-interference associated with the reception of the DL transmission associated with the at least one harmonic frequency resource. For example, referring to FIG. 8, the UE 804 may receive resource allocation 810 including, or indicating/allocating, “M” PRBs in a second frequency band.

In some aspects, the UE may transmit, to the network node, an indication of frequency resources within the second range of frequencies that are associated with an interference from harmonic frequencies of the first range of frequencies. In some aspects, the indication may also identify characteristics of the at least one harmonic frequency resource. For example, the indication may include characteristics of linear, and/or non-linear, IMD that may be used to identify the at least one harmonic frequency resource. The at least one harmonic frequency resource, in some aspects, may include a first set of “K” PRBs of the allocated DL resources that may be impacted by “J” PRBs of the allocated UL resources in the first range of frequencies, e.g., by linear, and/or non-linear, IMD associated with the first range of frequencies spanned by the “N” PRBs of the allocated UL resources. In some aspects, the indication of the frequency resources may include an indication of resources within the first frequency range for which the UL transmission is scheduled (indicating that a transmission of UL data will be transmitted via the indicated resources as opposed to the potential transmission associated with allocated UL resources that may not be utilized for UL data transmission). Adjustments to one or more of an UL transmission or a DL transmission, in some aspects, may be based on the indication of the frequency resources. For example, referring to FIG. 8, the UE 804 may transmit UE capability indication 812 or self-interference information 816 including an indication of the “K” PRBs impacted by at least a portion of the allocated UL resources (e.g., “J” PRBs of “N” allocated PRBs for UL transmissions) or including (or indicating) scheduled UL resources within the allocated UL resources.

The UE, in some aspects, may transmit, to the network node, one or more additional UE capability indications of whether the UE supports one or more of: the adjusting the reception of the DL transmission via the rate matching around the allocated DL resources that overlap with the at least one harmonic frequency resource to the UL resources, the reception of the DL transmission based on the increased DL transmission power in the at least one harmonic frequency resource, the reception of the DL transmission with the lower order MCS in the at least one harmonic frequency resource, or transmission of the UL transmission with the reduced UL transmission power in at least one resource having the at least one harmonic frequency resource allocated for the DL transmission. In some aspects, separate indications of support may be transmitted for each self-interference avoidance or mitigation method supported by the UE. For example, referring to FIG. 8, the UE 804 may transmit UE capability indication 812 indicating one or more of whether the UE supports self-interference avoidance for DL resources in the first set of (impacted/effected/interfered with) frequency resources (e.g., self-interference avoidance for an inter-band CA mode on the impacted downlink PRBs) based on DL rate matching, whether the UE supports self-interference mitigation based on adjusting (e.g., increasing) DL transmission power, whether the UE supports self-interference mitigation based on adjusting (e.g., decreasing) UL transmission power, or whether the UE supports self-interference mitigation based on adjusting (e.g., decreasing) an MCS for the DL transmission.

In some aspects, the UE may receive, from the network node, configuration information for adjusting, based on the DL resources including at least one harmonic frequency resource that is harmonic to the UL resources, one of an UL transmission in the UL resources or a reception of a DL transmission in the DL resources. In some aspects, the configuration information may include a condition for the adjusting including, or based on, one or more of: an occurrence of an at least partial overlap of the DL resources and the at least one harmonic frequency resource, an additional reception of an indication for the UE to rate match the DL transmission based on the at least partial overlap of the DL resources and the at least one harmonic frequency resource to the UL resources, an MCS of the DL transmission, or a transmission power of the UL transmission. In some aspects, the configuration information may include one or more of an MCS threshold or an UL transmission power threshold. In some aspects, the configuration information may indicate at least one additional time resource or at least one additional frequency resource associated with the DL rate matching, where the at least one additional time resource or the at least one additional frequency resource may be adjacent to the at least one harmonic frequency resource. The configuration information, in some aspects, may include one or more of an additional indication of an increased DL transmission power associated with the at least one harmonic frequency resource, and at least one range of frequencies in which the increased DL transmission power will be used for the DL transmission. In some aspects, the configuration information may indicate that a reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission, or an additional indication to reduce an UL transmission power. For example, referring to FIG. 8, the UE 804 may receive the self-interference avoidance/mitigation configuration 814 configuring one or more self-interference avoidance and/or mitigation methods for the UE 804.

In association with a particular UL/DL transmission/reception, the UE may determine if the UE has received an indication to adjust the UL transmission or DL reception and/or whether a configured criteria for adjusting the UL transmission or DL reception has been met. In some aspects, the indication for the UE to adjust the UL transmission or DL reception may be received in one of: first DCI scheduling the DL transmission, second DCI scheduling the UL transmission the UL transmission or DL reception, RRC signaling associated with DL SPS PDSCH, or a MAC-CE. If the UE determines that no indication to adjust the UL transmission or DL reception has been received and/or that a configured criteria for adjusting the UL transmission or DL reception has not been met, it may proceed to wait for a next UL/DL transmission/reception, and determine if the UE has received an indication to adjust the UL transmission or DL reception and/or whether a configured criteria for adjusting the UL transmission or DL reception has been met for the next (or current) UL/DL transmission/reception. For example, referring to FIG. 8, the UE 804 may, at 820, determine to perform an adjustment to a DL reception and/or an UL transmission. In some aspects, the determination at the UE 804 may occur after (and be based on) the reception of the self-interference avoidance/mitigation activation 818.

If the UE determines that the UE has received an indication to adjust the UL transmission or DL reception and/or whether a configured criteria for adjusting the UL transmission or DL reception has been met, the UE may, at 914 adjust, based on the DL resources including at least one harmonic frequency resource that is harmonic to the UL resources, one of an UL transmission in the UL resources or a reception of a DL transmission in the DL resources. In some aspects, the adjusting may be associated with one or more of: receiving, at 915 the DL transmission based on a DL rate matching around the at least one harmonic frequency resource, receiving, at 916, the DL transmission based on an increased DL transmission power of the DL transmission in the at least one harmonic frequency resource, transmitting, at 917, the UL transmission based on a reduced UL transmission power for the UL transmission in the UL resources associated with the at least one harmonic frequency resource, or receiving, at 918, the DL transmission based on a lower order MCS for the DL transmission in the at least one harmonic frequency resource. For example, 914-1118 may be performed by application processor(s) 1306, cellular baseband processor(s) 1324, transceiver(s) 1322, antenna(s) 1380, and/or self-interference handling component 198 of FIG. 13. For example, referring to FIG. 8, the UE 804 may, at 822, adjust an UL transmission and/or a DL reception.

In some aspects, the adjusting at 914 may include adjusting the reception, at 915, of the DL transmission in the second allocation of the DL resources, where the adjusting may be based on the DL rate matching around allocated resources that overlap with the at least one harmonic frequency resource to the UL resources. The adjusting, in some aspects, may be based on a condition related to one or more of: an occurrence of an at least partial overlap of the DL resources and the at least one harmonic frequency resource to the UL resources, a reception of an indication for the UE to rate match the DL transmission based on the at least partial overlap of the DL resources and the at least one harmonic frequency resource to the UL resources, an MCS of the DL transmission, or a transmission power of the UL transmission. In some aspects, the condition for the adjusting may be based on (or related to) the MCS of the DL transmission or the UL transmission in comparison to an MCS threshold. The condition for the adjusting may be based on (or related to) the transmission power of the UL transmission meeting a power threshold.

In some aspects, the UL resources may include resources allocated for a reference signal, and the UL resources (e.g., the UL resources allocated for the RS) may include empty resource elements in which the reference signal is not transmitted. The adjusting, in some aspects may include the DL rate matching around resource elements in which the reference signal is transmitted and not DL rate matching around the empty resource elements in which the reference signal is not transmitted. In some aspects, adjusting of one of the UL transmission in the UL resources or the reception of the DL transmission in the DL resources may include adjusting the one of the UL transmission or the reception of the DL transmission in at least one additional time resource or at least one additional frequency resource, where the at least one additional time resource or the at least one additional frequency resource may be adjacent to the at least one harmonic frequency resource to the UL resources. For example, referring to FIG. 8, at 822A, the base station 802 may perform DL rate matching around the impacted DL resources (e.g., the first set of (impacted/effected/interfered with) frequency resources or first set of “K” PRBs of the allocated DL resources that may be impacted by “J” PRBs of the allocated UL resources) and the UE 804 may receive the adjusted DL transmission and perform a corresponding adjustment to a decoding of the rate-matched DL transmission.

The adjusting at 914, in some aspects, may include receiving, at 916, the DL transmission in the DL resources based on the increased DL transmission power of the DL transmission in the at least one harmonic frequency resource. In some aspects, the DL transmission may have, or be associated with, different transmission powers for the at least one harmonic frequency resource and a non-harmonic frequency resource that is not harmonic to the UL resources, or the UL transmission, (e.g., an increased DL transmission power for the at least one harmonic frequency resource to the UL transmission and an unchanged, or reduced, DL transmission power for the non-harmonic frequency resource to the UL resources/transmission). As discussed above, an additional indication of the increased DL transmission power associated with the at least one harmonic frequency resource to the UL transmission, and/or at least one range of frequencies in which the increased DL transmission power will be used for the DL transmission may be received from the network node. For example, referring to FIG. 8, at 822B, the base station 802, in some aspects may adjust a DL transmission power of one or more DL resources of the allocated DL resources and the UE 804 may receive the adjusted DL transmission and perform a corresponding adjustment to a decoding of the adjusted DL transmission.

In some aspects, the adjusting at 914, may include transmitting, at 917, the UL transmission with a reduced transmission power for at least a subset of resources that have the at least one harmonic frequency resource in the DL resources. Transmitting the UL transmission, in some aspects, may include transmitting the UL transmission with a first transmission power in the subset of resources that have the at least one harmonic frequency resource in the DL resources, and transmitting the UL transmission with a second transmission power in a resource that does not have the at least one harmonic frequency resource in the DL resources. In some aspects, the first transmission power may be lower than the second transmission power. Transmitting the UL transmission based on the reduced UL transmission power for the UL transmission in the UL resources, in some aspects, may include maintaining a total power per symbol based on a different EPRE for the subset of resources that have the at least one harmonic frequency resource in the DL resources and the resource that does not have the at least one harmonic frequency resource in the DL resources. In some aspects, the reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission or an additional indication to reduce the UL transmission power. For example, referring to FIG. 8, the UE 804, at 822C, may adjust (or reduce) a UL transmission power of one or more UL resources of the allocated UL resources.

The adjusting at 914, in some aspects, may include receiving, at 918, the DL transmission based on a lower order MCS of the DL transmission in the at least one harmonic frequency resource. In some aspects, the DL transmission may have different MCSs for the at least one harmonic frequency resource to the UL transmission and a non-harmonic frequency resource to the UL transmission (e.g., an decreased MCS for the at least one harmonic frequency resource to the UL transmission and an unchanged MCS for the non-harmonic frequency resource to the UL transmission). Receiving the DL transmission, in some aspects, may include receiving the DL transmission in at least the one harmonic frequency resource and an additional resource based on a first MCS, and receiving the DL transmission in the non-harmonic frequency resource based on a second MCS, where the first MCS may be a lower order than the second MCS (e.g., an MCS index of the first MCS may be lower than an MCS index of the second MCS). For example, referring to FIG. 8, the base station 802, at 822D, in some aspects may adjust an MCS (e.g., an MCS index or MCS value) of one or more DL resources of the allocated DL resources and the UE 804 may receive the adjusted DL transmission and perform a corresponding adjustment to a decoding of the adjusted DL transmission.

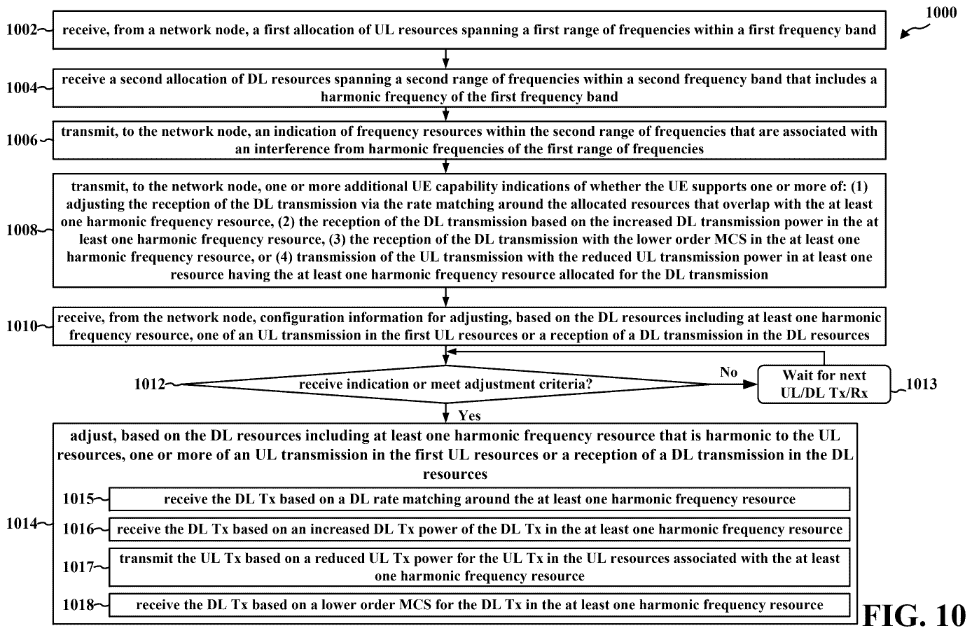

FIG. 10 is a flowchart 1000 of a method of wireless communication. The method may be performed by a wireless device such as a UE (e.g., the UE 104, 504, 804; the apparatus 1304). At 1002, the UE may receive, from a network node, a first allocation of UL resources spanning a first range of frequencies within a first frequency band. For example, 1002 may be performed by application processor(s) 1306, cellular baseband processor(s) 1324, transceiver(s) 1322, antenna(s) 1380, and/or self-interference handling component 198 of FIG. 13. In some aspects, the first frequency band may include at least a portion of FR1 or a C band (e.g., a frequency band centered around 3.5 GHZ, such as 3-4 GHz or 3.25-3.75 GHz). For example, referring to FIG. 8, the UE 804 may receive resource allocation 810 including, or indicating/allocating, “N” PRBs in a first frequency band.

At 1004, the UE may receive, from the network node, a second allocation of DL resources spanning a second range of frequencies within a second frequency band that includes a harmonic of the first frequency band. For example, 1004 may be performed by application processor(s) 1306, cellular baseband processor(s) 1324, transceiver(s) 1322, antenna(s) 1380, and/or self-interference handling component 198 of FIG. 13.

In some aspects, the UL resources and the DL resources may be associated with one of inter-band carrier aggregation or inter-band dual connectivity. In some aspects, the second frequency band may include at least part of a 6-8 GHz frequency range, and the allocated DL resources at least partially overlap with (or include) the at least one harmonic frequency resource (e.g., a resource that is associated with a frequency that is twice that of at least one UL resource). The at least one harmonic frequency resource may be a second harmonic of at least one frequency included in the first range of frequencies corresponding to the at least one harmonic frequency resource, and an UL transmission associated with the at least one frequency included in the first range of frequencies may be a source of self-interference associated with the reception of the DL transmission associated with the at least one harmonic frequency resource. For example, referring to FIG. 8, the UE 804 may receive resource allocation 810 including, or indicating/allocating, “M” PRBs in a second frequency band.

At 1006, the UE may transmit, to the network node, an additional indication of frequency resources within the second range of frequencies that are associated with an interference from harmonic frequencies of the first range of frequencies. For example, 1006 may be performed by application processor(s) 1306, cellular baseband processor(s) 1324, transceiver(s) 1322, antenna(s) 1380, and/or self-interference handling component 198 of FIG. 13. In some aspects, the indication may also identify characteristics of the at least one harmonic frequency resource. For example, the indication may include characteristics of linear, and/or non-linear, IMD that may be used to identify the at least one harmonic frequency resource. The at least one harmonic frequency resource, in some aspects, may include a first set of “K” PRBs of the allocated DL resources that may be impacted by “J” PRBs of the allocated UL resources in the first range of frequencies, e.g., by linear, and/or non-linear, IMD associated with the first range of frequencies spanned by the “N” PRBs of the allocated UL resources. In some aspects, the indication of the frequency resources may include an indication of resources within the first frequency range for which the UL transmission is scheduled (indicating that a transmission of UL data will be transmitted via the indicated resources as opposed to the potential transmission associated with allocated UL resources that may not be utilized for UL data transmission). Adjustments to one or more of an UL transmission or a DL transmission, in some aspects, may be based on the indication of the frequency resources. For example, referring to FIG. 8, the UE 804 may transmit UE capability indication 812 or self-interference information 816 including an indication of the “K” PRBs impacted by at least a portion of the allocated UL resources (e.g., “J” PRBs of “N” allocated PRBs for UL transmissions) or including (or indicating) scheduled UL resources within the allocated UL resources.

At 1008, the UE may transmit, to the network node, one or more additional UE capability indications of whether the UE supports one or more of: the adjusting the reception of the DL transmission via the rate matching around the allocated DL resources that overlap with the at least one harmonic frequency resource to the UL resources, the reception of the DL transmission based on the increased DL transmission power in the at least one harmonic frequency resource, the reception of the DL transmission with the lower order MCS in the at least one harmonic frequency resource, or transmission of the UL transmission with the reduced UL transmission power in at least one resource having the at least one harmonic frequency resource allocated for the DL transmission. For example, 1008 may be performed by application processor(s) 1306, cellular baseband processor(s) 1324, transceiver(s) 1322, antenna(s) 1380, and/or self-interference handling component 198 of FIG. 13. In some aspects, separate indications of support may be transmitted for each self-interference avoidance or mitigation method supported by the UE. For example, referring to FIG. 8, the UE 804 may transmit UE capability indication 812 indicating one or more of whether the UE supports self-interference avoidance for DL resources in the first set of (impacted/effected/interfered with) frequency resources (e.g., self-interference avoidance for an inter-band CA mode on the impacted downlink PRBs) based on DL rate matching, whether the UE supports self-interference mitigation based on adjusting (e.g., increasing) DL transmission power, whether the UE supports self-interference mitigation based on adjusting (e.g., decreasing) UL transmission power, or whether the UE supports self-interference mitigation based on adjusting (e.g., decreasing) an MCS for the DL transmission.

At 1010, the UE may receive, from the network node, configuration information for adjusting, based on the DL resources including at least one harmonic frequency resource that is harmonic to the UL resources, one of an UL transmission in the UL resources or a reception of a DL transmission in the DL resources. For example, 1010 may be performed by application processor(s) 1306, cellular baseband processor(s) 1324, transceiver(s) 1322, antenna(s) 1380, and/or self-interference handling component 198 of FIG. 13. In some aspects, the configuration information may include a condition for the adjusting including, or based on, one or more of: an occurrence of an at least partial overlap of the DL resources and the at least one harmonic frequency resource to the UL resources, a reception of an indication for the UE to rate match the DL transmission based on the at least partial overlap of the DL resources and the at least one harmonic frequency resource to the UL resources, an MCS of the DL transmission, or a transmission power of the UL transmission. In some aspects, the configuration information may include one or more of an MCS threshold or an UL transmission power threshold. In some aspects, the configuration information may indicate at least one additional time resource or at least one additional frequency resource associated with the DL rate matching, where the at least one additional time resource or the at least one additional frequency resource may be adjacent to the at least one harmonic frequency resource to the UL resources. The configuration information, in some aspects, may include one or more of an additional indication of an increased DL transmission power associated with the at least one harmonic frequency resource to the UL transmission, and at least one range of frequencies in which the increased DL transmission power will be used for the DL transmission. In some aspects, the configuration information may indicate that a reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission, or an additional indication to reduce the UL transmission power. For example, referring to FIG. 8, the UE 804 may receive the self-interference avoidance/mitigation configuration 814 configuring one or more self-interference avoidance and/or mitigation methods for the UE 804.

In association with a particular UL/DL transmission/reception, the UE, at 1012, may determine if the UE has received an indication to adjust the UL transmission or DL reception and/or whether a configured criteria for adjusting the UL transmission or DL reception has been met. For example, 1012 may be performed by application processor(s) 1306, cellular baseband processor(s) 1324, transceiver(s) 1322, antenna(s) 1380, and/or self-interference handling component 198 of FIG. 13. In some aspects, the indication for the UE to adjust the UL transmission or DL reception may be received in one of: first DCI scheduling the DL transmission, second DCI scheduling the UL transmission the UL transmission or DL reception, RRC signaling associated with DL SPS PDSCH, or a MAC-CE. If the UE determines that no indication to adjust the UL transmission or DL reception has been received and/or that a configured criteria for adjusting the UL transmission or DL reception has not been met, it may proceed to 1013 to wait for a next UL/DL transmission/reception, and determine if the UE has received an indication to adjust the UL transmission or DL reception and/or whether a configured criteria for adjusting the UL transmission or DL reception has been met for the next (or current) UL/DL transmission/reception. For example, referring to FIG. 8, the UE 804 may, at 820, determine to perform an adjustment to a DL reception and/or an UL transmission. In some aspects, the determination at the UE 804 may occur after (and be based on) the reception of the self-interference avoidance/mitigation activation 818.

If the UE determines, at 1012, that the UE has received an indication to adjust the UL transmission or DL reception and/or whether a configured criteria for adjusting the UL transmission or DL reception has been met, the UE may, at 1014 adjust, based on the DL resources including at least one harmonic frequency resource that is harmonic to the UL resources, one of an UL transmission in the UL resources or a reception of a DL transmission in the DL resources. In some aspects, the adjusting may be associated with one or more of: receiving, at 1015 the DL transmission based on a DL rate matching around the at least one harmonic frequency resource, receiving, at 1016, the DL transmission based on an increased DL transmission power of the DL transmission in the at least one harmonic frequency resource, transmitting, at 1017, the UL transmission based on a reduced UL transmission power for the UL transmission in the UL resources associated with the at least one harmonic frequency resource, or receiving, at 1018, the DL transmission based on a lower order MCS for the DL transmission in the at least one harmonic frequency resource. For example, 1014-1118 may be performed by application processor(s) 1306, cellular baseband processor(s) 1324, transceiver(s) 1322, antenna(s) 1380, and/or self-interference handling component 198 of FIG. 13. For example, referring to FIG. 8, the UE 804 may, at 822, adjust an UL transmission and/or a DL reception.

In some aspects, the adjusting at 1014 may include adjusting the reception, at 1015, of the DL transmission in the second allocation of the DL resources, where the adjusting may be based on the DL rate matching around allocated resources that overlap with the at least one harmonic frequency resource to the UL resources. The adjusting, in some aspects, may be based on a condition related to one or more of: an occurrence of an at least partial overlap of the DL resources and the at least one harmonic frequency resource to the UL resources, a reception of an indication for the UE to rate match the DL transmission based on the at least partial overlap of the DL resources and the at least one harmonic frequency resource to the UL resources, an MCS of the DL transmission, or a transmission power of the UL transmission. In some aspects, the condition for the adjusting may be based on (or related to) the MCS of the DL transmission or the UL transmission in comparison to an MCS threshold. The condition for the adjusting may be based on (or related to) the transmission power of the UL transmission meeting a power threshold.

In some aspects, the UL resources may include resources allocated for a reference signal, and the UL resources (e.g., the UL resources allocated for the RS) may include empty resource elements in which the reference signal is not transmitted. The adjusting, in some aspects may include the DL rate matching around resource elements in which the reference signal is transmitted and not DL rate matching around the empty resource elements in which the reference signal is not transmitted. In some aspects, adjusting of one of the UL transmission in the UL resources or the reception of the DL transmission in the DL resources may include adjusting the one of the UL transmission or the reception of the DL transmission in at least one additional time resource or at least one additional frequency resource, where the at least one additional time resource or the at least one additional frequency resource may be adjacent to the at least one harmonic frequency resource to the UL resources. For example, referring to FIG. 8, at 822A, the base station 802 may perform DL rate matching around the impacted DL resources (e.g., the first set of (impacted/effected/interfered with) frequency resources or first set of “K” PRBs of the allocated DL resources that may be impacted by “J” PRBs of the allocated UL resources) and the UE 804 may receive the adjusted DL transmission and perform a corresponding adjustment to a decoding of the rate-matched DL transmission.

The adjusting at 1014, in some aspects, may include receiving, at 1016, the DL transmission in the DL resources based on the increased DL transmission power of the DL transmission in the at least one harmonic frequency resource. In some aspects, the DL transmission may have, or be associated with, different transmission powers for the at least one harmonic frequency resource to the UL transmission and a non-harmonic frequency resource that is not harmonic to the UL resources, or the UL transmission (e.g., an increased DL transmission power for the at least one harmonic frequency resource to the UL transmission and an unchanged, or reduced, DL transmission power for the non-harmonic frequency resource to the UL resources/transmission). As discussed above, an additional indication of the increased DL transmission power associated with the at least one harmonic frequency resource to the UL transmission, and/or at least one range of frequencies in which the increased DL transmission power will be used for the DL transmission may be received from the network node. For example, referring to FIG. 8, at 822B, the base station 802, in some aspects may adjust a DL transmission power of one or more DL resources of the allocated DL resources and the UE 804 may receive the adjusted DL transmission and perform a corresponding adjustment to a decoding of the adjusted DL transmission.

In some aspects, the adjusting at 1014, may include transmitting, at 1017, the UL transmission with a reduced transmission power for at least a subset of resources that have the at least one harmonic frequency resource in the DL resources. Transmitting the UL transmission, in some aspects, may include transmitting the UL transmission with a first transmission power in the subset of resources that have the at least one harmonic frequency resource in the DL resources, and transmitting the UL transmission with a second transmission power in a resource that does not have the at least one harmonic frequency resource in the DL resources. In some aspects, the first transmission power may be lower than the second transmission power. Transmitting the UL transmission based on the reduced UL transmission power for the UL transmission in the UL resources, in some aspects, may include maintaining a total power per symbol based on a different EPRE for the subset of resources that have the at least one harmonic frequency resource in the DL resources and the resource that does not have the at least one harmonic frequency resource in the DL resources. In some aspects, the reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission or an additional indication to reduce the UL transmission power. For example, referring to FIG. 8, the UE 804, at 822C, may adjust (or reduce) a UL transmission power of one or more UL resources of the allocated UL resources.

The adjusting at 1014, in some aspects, may include receiving, at 1018, the DL transmission based on a lower order MCS of the DL transmission in the at least one harmonic frequency resource. In some aspects, the DL transmission may have different MCSs for the at least one harmonic frequency resource to the UL transmission and a non-harmonic frequency resource to the UL transmission (e.g., an decreased MCS for the at least one harmonic frequency resource to the UL transmission and an unchanged MCS for the non-harmonic frequency resource to the UL transmission). Receiving the DL transmission, in some aspects, may include receiving the DL transmission in at least the one harmonic frequency resource and an additional resource based on a first MCS, and receiving the DL transmission in the non-harmonic frequency resource based on a second MCS, where the first MCS may be a lower order than the second MCS (e.g., an MCS index of the first MCS may be lower than an MCS index of the second MCS). For example, referring to FIG. 8, the base station 802, at 822D, in some aspects may adjust an MCS (e.g., an MCS index or MCS value) of one or more DL resources of the allocated DL resources and the UE 804 may receive the adjusted DL transmission and perform a corresponding adjustment to a decoding of the adjusted DL transmission.

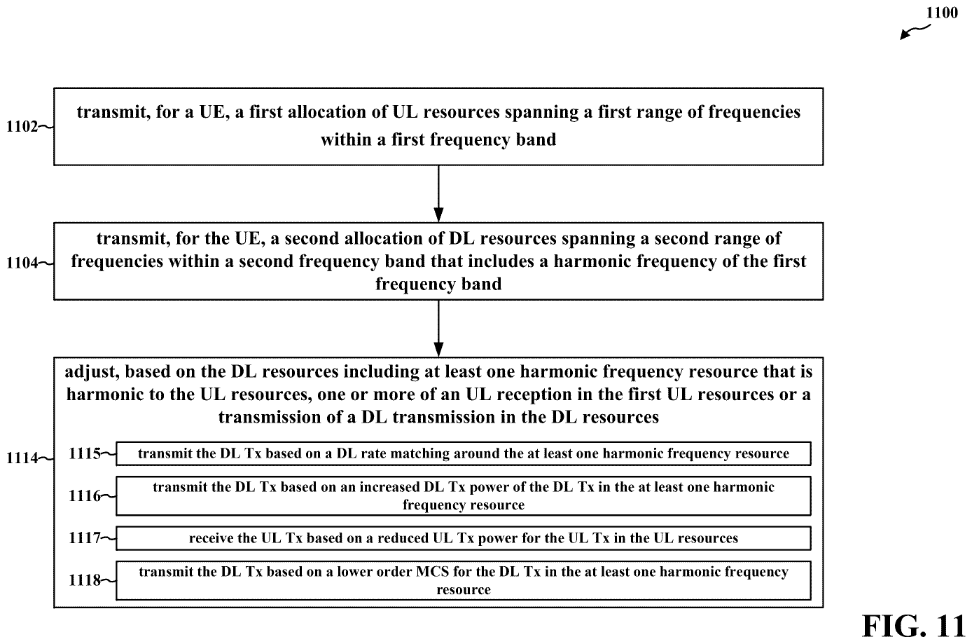

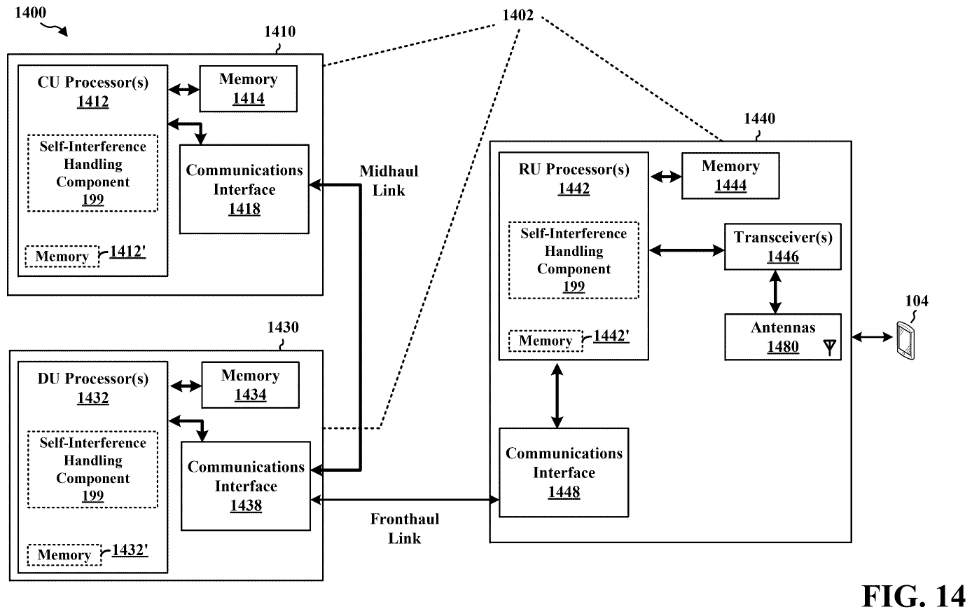

FIG. 11 is a flowchart 1100 of a method of wireless communication. The method may be performed by a network node such as a base station (e.g., the base station 102, 502, 802; the network entity 1302, 1402). At 1102, the network node may transmit, for a UE, a first allocation of UL resources spanning a first range of frequencies within a first frequency band. For example, 1102 may be performed by CU processor(s) 1412, DU processor(s) 1432, RU processor(s) 1442, transceiver(s) 1446, antenna(s) 1480, and/or self-interference handling component 199 of FIG. 14. In some aspects, the first frequency band may include at least a portion of FR1 or a C band (e.g., a frequency band centered around 3.5 GHZ, such as 3-4 GHz or 3.25-3.75 GHz). For example, referring to FIG. 8, the base station 802 may transmit resource allocation 810 including, or indicating/allocating, “N” PRBs in a first frequency band. At 1104, the network node may transmit, for the UE, a second allocation of DL resources spanning a second range of frequencies within a second frequency band that includes a harmonic of the first frequency band. For example, 1104 may be performed by CU processor(s) 1412, DU processor(s) 1432, RU processor(s) 1442, transceiver(s) 1446, antenna(s) 1480, and/or self-interference handling component 199 of FIG. 14. In some aspects, the UL resources and the DL resources may be associated with one of inter-band carrier aggregation or inter-band dual connectivity. In some aspects, the second frequency band may include at least part of a 6-8 GHz frequency range, and the allocated DL resources at least partially overlap with (or include) the at least one harmonic frequency resource to the UL resources (e.g., a resource that is associated with a frequency that is twice that of at least one UL resource). The at least one harmonic frequency resource may be a second harmonic of at least one frequency included in the first range of frequencies corresponding to the at least one harmonic frequency resource, and an UL transmission associated with the at least one frequency included in the first range of frequencies may be a source of self-interference associated with the reception of the DL transmission associated with the at least one harmonic frequency resource. For example, referring to FIG. 8, the base station 802 may transmit resource allocation 810 including, or indicating/allocating, “M” PRBs in a second frequency band.

In some aspects, the network node may receive, from the UE, an indication of frequency resources within the second range of frequencies that are associated with an interference from harmonic frequencies of the first range of frequencies. In some aspects, the indication may also identify characteristics of the at least one harmonic frequency resource. For example, the indication may include characteristics of linear, and/or non-linear, IMD that may be used to identify the at least one harmonic frequency resource. The at least one harmonic frequency resource, in some aspects, may include a first set of “K” PRBs of the allocated DL resources that may be impacted by “J” PRBs of the allocated UL resources in the first range of frequencies, e.g., by linear, and/or non-linear, IMD associated with the first range of frequencies spanned by the “N” PRBs of the allocated UL resources. In some aspects, the indication of the frequency resources may include an indication of resources within the first frequency range for which the UL transmission is scheduled (indicating that a transmission of UL data will be transmitted via the indicated resources as opposed to the potential transmission associated with allocated UL resources that may not be utilized for UL data transmission). Adjustments to one or more of an UL transmission or a DL transmission, in some aspects, may be based on the indication of the frequency resources. For example, referring to FIG. 8, the UE 804 may transmit, and the base station 802 may receive, UE capability indication 812 or self-interference information 816 including an indication of the “K” PRBs impacted by at least a portion of the allocated UL resources (e.g., “J” PRBs of “N” allocated PRBs for UL transmissions) or including (or indicating) scheduled UL resources within the allocated UL resources.

The network node, in some aspects, may receive, from the UE, one or more additional UE capability indications of whether the UE supports one or more of: the adjusting (a reception of) the DL transmission via the rate matching around the allocated DL resources that overlap with the at least one harmonic frequency resource to the UL resources, (a reception of) the DL transmission based on the increased DL transmission power in the at least one harmonic frequency resource, (a reception of) the DL transmission with the lower order MCS in the at least one harmonic frequency resource, or transmission of the UL transmission with the reduced UL transmission power in at least one resource having the at least one harmonic frequency resource allocated for the DL transmission. In some aspects, separate indications of support may be transmitted for each self-interference avoidance or mitigation method supported by the UE. For example, referring to FIG. 8, the UE 804 may transmit, and the base station 802 may receive, UE capability indication 812 indicating one or more of whether the UE supports self-interference avoidance for DL resources in the first set of (impacted/effected/interfered with) frequency resources (e.g., self-interference avoidance for an inter-band CA mode on the impacted downlink PRBs based on DL rate matching, whether the UE supports self-interference mitigation based on adjusting (e.g., increasing) DL transmission power, whether the UE supports self-interference mitigation based on adjusting (e.g., decreasing) UL transmission power, or whether the UE supports self-interference mitigation based on adjusting (e.g., decreasing) an MCS for the DL transmission.

In some aspects, the network node may transmit, for the UE, configuration information for adjusting, based on the DL resources including at least one harmonic frequency resource that is harmonic to the UL resources, one of an UL reception in the UL resources or a DL transmission in the DL resources. In some aspects, the configuration information may include a condition for the adjusting including, or based on, one or more of: an occurrence of an at least partial overlap of the DL resources and the at least one harmonic frequency resource to the UL resources, an additional reception of an indication for the UE to rate match the DL transmission based on the at least partial overlap of the DL resources and the at least one harmonic frequency resource to the UL resources, an MCS of the DL transmission, or a transmission power of the UL transmission. In some aspects, the configuration information may include one or more of an MCS threshold or an UL transmission power threshold. In some aspects, the configuration information may indicate at least one additional time resource or at least one additional frequency resource associated with the DL rate matching, where the at least one additional time resource or the at least one additional frequency resource may be adjacent to the at least one harmonic frequency resource to the UL resources. The configuration information, in some aspects, may include one or more of an additional indication of an increased DL transmission power associated with the at least one harmonic frequency resource to the UL transmission, and at least one range of frequencies in which the increased DL transmission power will be used for the DL transmission. In some aspects, the configuration information may indicate that a reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission, or an additional indication to reduce an UL transmission power. For example, referring to FIG. 8, the base station 802 may transmit, and the UE 804 may receive, the self-interference avoidance/mitigation configuration 814 configuring one or more self-interference avoidance and/or mitigation methods for the UE 804.

In association with a particular DL/UL transmission/reception, the network node, may determine whether a configured criteria for adjusting the DL transmission or UL reception has been met and/or whether to transmit an indication for the UE to adjust the UL transmission or DL reception. If the network node determines that a configured criteria for adjusting the DL transmission or UL reception has not been met and/or to not transmit an indication for the UE to adjust the UL transmission or DL reception, it may proceed to wait for a next DL/UL transmission/reception, and determine whether a configured criteria for adjusting the DL transmission or UL reception has been met and/or whether to transmit an indication for the UE to adjust the UL transmission or DL reception for the next (or current) DL/UL transmission/reception. For example, referring to FIG. 8, the base station 802 may, at 820, determine to perform an adjustment to a DL transmission and/or an UL reception and/or to transmit the self-interference avoidance/mitigation activation 818. In some aspects, the determination at the base station 802 may occur before the transmission of the self-interference avoidance/mitigation activation 818 (which may be based on the determination at 820).

If the network node determines that a configured criteria for adjusting the DL transmission or UL reception has been met and/or to transmit an indication for the UE to adjust the UL transmission or DL reception, the network node may transmit an indication for the UE to adjust the UL transmission or DL reception in one of: first DCI scheduling the DL transmission, second DCI scheduling the UL transmission the UL transmission or DL reception, RRC signaling associated with DL SPS PDSCH, or a MAC-CE. If no indication is sent (if a determination to adjust the UL/DL transmission/reception is rules based at both the UR and the network node), the network node may, at 1114 adjust, based on the DL resources including at least one harmonic frequency resource that is harmonic to the UL resources, one of an UL reception in the UL resources or a DL transmission in the DL resources. In some aspects, the adjusting may be associated with one or more of: transmitting, at 1115 the DL transmission based on a DL rate matching around the at least one harmonic frequency resource, transmitting, at 1116, the DL transmission based on an increased DL transmission power of the DL transmission in the at least one harmonic frequency resource, receiving, at 1117, the UL transmission based on a reduced UL transmission power for the UL transmission in the UL resources associated with the at least one harmonic frequency resource, or transmitting, at 1118, the DL transmission based on a lower order MCS for the DL transmission in the at least one harmonic frequency resource. For example, 1114-1118 may be performed by CU processor(s) 1412, DU processor(s) 1432, RU processor(s) 1442, transceiver(s) 1446, antenna(s) 1480, and/or self-interference handling component 199 of FIG. 14. For example, referring to FIG. 8, the base station 802 may, at 822, adjust an UL reception and/or a DL transmission.

In some aspects, the adjusting at 1114 may include adjusting the transmission, at 1115, of the DL transmission in the second allocation of the DL resources, where the adjusting may be based on the DL rate matching around allocated resources that overlap with the at least one harmonic frequency resource to the UL resources. The adjusting, in some aspects, may be based on a condition related to one or more of: an occurrence of an at least partial overlap of the DL resources and the at least one harmonic frequency resource to the UL resources, a transmission of an indication for the UE to rate match the DL transmission based on the at least partial overlap of the DL resources and the at least one harmonic frequency resource to the UL resources, an MCS of the DL transmission, or a transmission power of the UL transmission. In some aspects, the condition for the adjusting may be based on (or related to) the MCS of the DL transmission or the UL transmission in comparison to an MCS threshold. The condition for the adjusting may be based on (or related to) the transmission power of the UL transmission meeting a power threshold.

In some aspects, the UL resources may include resources allocated for a reference signal, and the UL resources (e.g., the UL resources allocated for the RS) may include empty resource elements in which the reference signal is not transmitted. The adjusting, in some aspects may include the DL rate matching around resource elements in which the reference signal is transmitted and not DL rate matching around the empty resource elements in which the reference signal is not transmitted. In some aspects, adjusting of one of the UL reception in the UL resources or the transmission of the DL transmission in the DL resources may include adjusting the one of the UL reception or the DL transmission in at least one additional time resource or at least one additional frequency resource, where the at least one additional time resource or the at least one additional frequency resource may be adjacent to the at least one harmonic frequency resource to the UL resources. For example, referring to FIG. 8, at 822A, the base station 802 may perform DL rate matching around the impacted DL resources (e.g., the first set of (impacted/effected/interfered with) frequency resources or first set of “K” PRBs of the allocated DL resources that may be impacted by “J” PRBs of the allocated UL resources) and the UE 804 may receive the adjusted DL transmission and perform a corresponding adjustment to a decoding of the rate-matched DL transmission.

The adjusting at 1114, in some aspects, may include transmitting, at 1116, the DL transmission in the DL resources based on the increased DL transmission power of the DL transmission in the at least one harmonic frequency resource. In some aspects, the DL transmission may have, or be associated with, different transmission powers for the at least one harmonic frequency resource to the UL transmission and a non-harmonic frequency resource that is not harmonic to the UL resources, or the UL transmission (e.g., an increased DL transmission power for the at least one harmonic frequency resource to the UL transmission and an unchanged, or reduced, DL transmission power for the non-harmonic frequency resource to the UL resources/transmission). As discussed above, an additional indication of the increased DL transmission power associated with the at least one harmonic frequency resource to the UL transmission, and/or at least one range of frequencies in which the increased DL transmission power will be used for the DL transmission may be transmitted by the network node. For example, referring to FIG. 8, at 822B, the base station 802, in some aspects may adjust a DL transmission power of one or more DL resources of the allocated DL resources and the UE 804 may receive the adjusted DL transmission and perform a corresponding adjustment to a decoding of the adjusted DL transmission, where a power associated with the adjusted (e.g., increased) DL transmission power may be received in the self-interference avoidance/mitigation configuration 814.

In some aspects, the adjusting at 1114, may include receiving, at 1117, the UL transmission with a reduced transmission power for at least a subset of resources that have the at least one harmonic frequency resource in the DL resources. Receiving the UL transmission, in some aspects, may include receiving the UL transmission with a first transmission power in the subset of resources that have the at least one harmonic frequency resource in the DL resources, and receiving the UL transmission with a second transmission power in a resource that does not have the at least one harmonic frequency resource in the DL resources. In some aspects, the first transmission power may be lower than the second transmission power. A total power per symbol, in some aspects, may be maintained based on a different EPRE for the subset of resources that have the at least one harmonic frequency resource in the DL resources and the resource that does not have the at least one harmonic frequency resource in the DL resources. In some aspects, the reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission or an additional indication to reduce the UL transmission power. For example, referring to FIG. 8, the UE 804, at 822C, may adjust (or reduce) a UL transmission power of one or more UL resources of the allocated UL resources and the base station 802 may receive the adjusted UL transmission and perform a corresponding adjustment to a decoding of the adjusted UL transmission.

The adjusting at 1114, in some aspects, may include transmitting, at 1118, the DL transmission based on a lower order MCS of the DL transmission in the at least one harmonic frequency resource. In some aspects, the DL transmission may have different MCSs for the at least one harmonic frequency resource to the UL transmission and a non-harmonic frequency resource to the UL transmission (e.g., an decreased MCS for the at least one harmonic frequency resource to the UL transmission and an unchanged MCS for the non-harmonic frequency resource to the UL transmission). Transmitting the DL transmission, in some aspects, may include transmitting the DL transmission in at least the one harmonic frequency resource and an additional resource based on a first MCS, and transmitting the DL transmission in the non-harmonic frequency resource based on a second MCS, where the first MCS may be a lower order than the second MCS (e.g., an MCS index of the first MCS may be lower than an MCS index of the second MCS). For example, referring to FIG. 8, the base station 802, at 822D, in some aspects may adjust an MCS (e.g., an MCS index or MCS value) of one or more DL resources of the allocated DL resources.

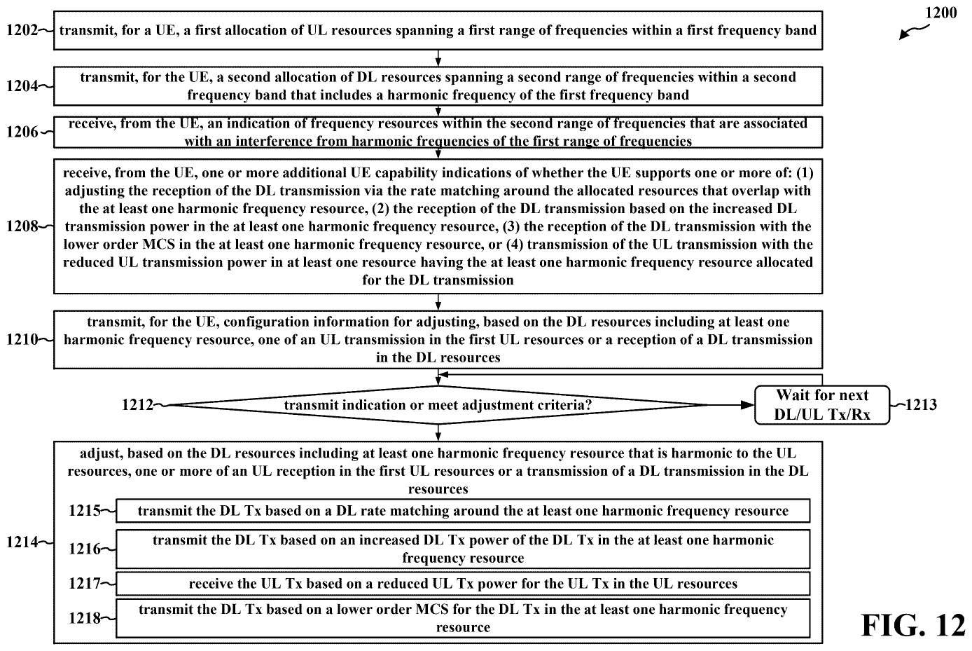

FIG. 12 is a flowchart 1200 of a method of wireless communication. The method may be performed by a network node such as a base station (e.g., the base station 102, 502, 802; the network entity 1302, 1402). At 1202, the network node may transmit, for a UE, a first allocation of UL resources spanning a first range of frequencies within a first frequency band. For example, 1202 may be performed by CU processor(s) 1412, DU processor(s) 1432, RU processor(s) 1442, transceiver(s) 1446, antenna(s) 1480, and/or self-interference handling component 199 of FIG. 14. In some aspects, the first frequency band may include at least a portion of FR1 or a C band (e.g., a frequency band centered around 3.5 GHZ, such as 3-4 GHz or 3.25-3.75 GHz). For example, referring to FIG. 8, the base station 802 may transmit resource allocation 810 including, or indicating/allocating, “N” PRBs in a first frequency band.

At 1204, the network node may transmit, for the UE, a second allocation of DL resources spanning a second range of frequencies within a second frequency band that includes a harmonic of the first frequency band. For example, 1204 may be performed by CU processor(s) 1412, DU processor(s) 1432, RU processor(s) 1442, transceiver(s) 1446, antenna(s) 1480, and/or self-interference handling component 199 of FIG. 14. In some aspects, the UL resources and the DL resources may be associated with one of inter-band carrier aggregation or inter-band dual connectivity. In some aspects, second frequency band may include at least part of a 6-8 GHz frequency range, and the allocated DL resources at least partially overlap with (or include) the at least one harmonic frequency resource (e.g., a resource that is associated with a frequency that is twice that of at least one UL resource). The at least one harmonic frequency resource may be a second harmonic of at least one frequency included in the first range of frequencies corresponding to the at least one harmonic frequency resource, and an UL transmission associated with the at least one frequency included in the first range of frequencies may be a source of self-interference associated with the reception of the DL transmission associated with the at least one harmonic frequency resource. For example, referring to FIG. 8, the base station 802 may transmit resource allocation 810 including, or indicating/allocating, “M” PRBs in a second frequency band.

At 1206, the network node may receive, from the UE, an additional indication of frequency resources within the second range of frequencies that are associated with an interference from harmonic frequencies of the first range of frequencies. For example, 1206 may be performed by CU processor(s) 1412, DU processor(s) 1432, RU processor(s) 1442, transceiver(s) 1446, antenna(s) 1480, and/or self-interference handling component 199 of FIG. 14. In some aspects, the indication may also identify characteristics of the at least one harmonic frequency resource. For example, the indication may include characteristics of linear, and/or non-linear, IMD that may be used to identify the at least one harmonic frequency resource. The at least one harmonic frequency resource, in some aspects, may include a first set of “K” PRBs of the allocated DL resources that may be impacted by “J” PRBs of the allocated UL resources in the first range of frequencies, e.g., by linear, and/or non-linear, IMD associated with the first range of frequencies spanned by the “N” PRBs of the allocated UL resources. In some aspects, the indication of the frequency resources may include an indication of resources within the first frequency range for which the UL transmission is scheduled (indicating that a transmission of UL data will be transmitted via the indicated resources as opposed to the potential transmission associated with allocated UL resources that may not be utilized for UL data transmission). Adjustments to one or more of an UL transmission or a DL transmission, in some aspects, may be based on the indication of the frequency resources. For example, referring to FIG. 8, the UE 804 may transmit, and the base station 802 may receive, UE capability indication 812 or self-interference information 816 including an indication of the “K” PRBs impacted by at least a portion of the allocated UL resources (e.g., “J” PRBs of “N” allocated PRBs for UL transmissions) or including (or indicating) scheduled UL resources within the allocated UL resources.

At 1208, the network node may receive, from the UE, one or more additional UE capability indications of whether the UE supports one or more of: the adjusting (a reception of) the DL transmission via the rate matching around the allocated DL resources that overlap with the at least one harmonic frequency resource to the UL resources, (a reception of) the DL transmission based on the increased DL transmission power in the at least one harmonic frequency resource, (a reception of) the DL transmission with the lower order MCS in the at least one harmonic frequency resource, or transmission of the UL transmission with the reduced UL transmission power in at least one resource having the at least one harmonic frequency resource allocated for the DL transmission. For example, 1208 may be performed by CU processor(s) 1412, DU processor(s) 1432, RU processor(s) 1442, transceiver(s) 1446, antenna(s) 1480, and/or self-interference handling component 199 of FIG. 14. In some aspects, separate indications of support may be transmitted for each self-interference avoidance or mitigation method supported by the UE. For example, referring to FIG. 8, the UE 804 may transmit, and the base station 802 may receive, UE capability indication 812 indicating one or more of whether the UE supports self-interference avoidance for DL resources in the first set of (impacted/effected/interfered with) frequency resources (e.g., self-interference avoidance for an inter-band CA mode on the impacted downlink PRBs based on DL rate matching, whether the UE supports self-interference mitigation based on adjusting (e.g., increasing) DL transmission power, whether the UE supports self-interference mitigation based on adjusting (e.g., decreasing) UL transmission power, or whether the UE supports self-interference mitigation based on adjusting (e.g., decreasing) an MCS for the DL transmission.

At 1210, the network node may transmit, for the UE, configuration information for adjusting, based on the DL resources including at least one harmonic frequency resource that is harmonic to the UL resources, one of an UL reception in the UL resources or a DL transmission in the DL resources. For example, 1210 may be performed by CU processor(s) 1412, DU processor(s) 1432, RU processor(s) 1442, transceiver(s) 1446, antenna(s) 1480, and/or self-interference handling component 199 of FIG. 14. In some aspects, the configuration information may include a condition for the adjusting including, or based on, one or more of: an occurrence of an at least partial overlap of the DL resources and the at least one harmonic frequency resource to the UL resources, a reception of an indication for the UE to rate match the DL transmission based on the at least partial overlap of the DL resources and the at least one harmonic frequency resource to the UL resources, an MCS of the DL transmission, or a transmission power of the UL transmission. In some aspects, the configuration information may include one or more of an MCS threshold or an UL transmission power threshold. In some aspects, the configuration information may indicate at least one additional time resource or at least one additional frequency resource associated with the DL rate matching, where the at least one additional time resource or the at least one additional frequency resource may be adjacent to the at least one harmonic frequency resource to the UL resources. The configuration information, in some aspects, may include one or more of an additional indication of an increased DL transmission power associated with the at least one harmonic frequency resource to the UL transmission, and at least one range of frequencies in which the increased DL transmission power will be used for the DL transmission. In some aspects, the configuration information may indicate that a reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission, or an additional indication to reduce the UL transmission power. For example, referring to FIG. 8, the base station 802 may transmit, and the UE 804 may receive, the self-interference avoidance/mitigation configuration 814 configuring one or more self-interference avoidance and/or mitigation methods for the UE 804.

In association with a particular DL/UL transmission/reception, the network node, at 1212, may determine whether a configured criteria for adjusting the DL transmission or UL reception has been met and/or whether to transmit an indication for the UE to adjust the UL transmission or DL reception. For example, 1212 may be performed by CU processor(s) 1412, DU processor(s) 1432, RU processor(s) 1442, transceiver(s) 1446, antenna(s) 1480, and/or self-interference handling component 199 of FIG. 14. If the network node determines that a configured criteria for adjusting the DL transmission or UL reception has not been met and/or to not transmit an indication for the UE to adjust the UL transmission or DL reception, it may proceed to 1213 to wait for a next DL/UL transmission/reception, and determine whether a configured criteria for adjusting the DL transmission or UL reception has been met and/or whether to transmit an indication for the UE to adjust the UL transmission or DL reception for the next (or current) DL/UL transmission/reception. For example, referring to FIG. 8, the base station 802 may, at 820, determine to perform an adjustment to a DL transmission and/or an UL reception and/or to transmit the self-interference avoidance/mitigation activation 818. In some aspects, the determination at the base station 802 may occur before the transmission of the self-interference avoidance/mitigation activation 818 (which may be based on the determination at 820).

If the network node determines, at 1212, that a configured criteria for adjusting the DL transmission or UL reception has been met and/or to transmit an indication for the UE to adjust the UL transmission or DL reception, the network node may transmit an indication for the UE to adjust the UL transmission or DL reception in one of: first DCI scheduling the DL transmission, second DCI scheduling the UL transmission the UL transmission or DL reception, RRC signaling associated with DL SPS PDSCH, or a MAC-CE. If no indication is sent at 1212 (if a determination to adjust the UL/DL transmission/reception is rules based at both the UR and the network node), the network node may, at 1214 adjust, based on the DL resources including at least one harmonic frequency resource that is harmonic to the UL resources, one of an UL reception in the UL resources or a DL transmission in the DL resources. In some aspects, the adjusting may be associated with one or more of: transmitting, at 1215 the DL transmission based on a DL rate matching around the at least one harmonic frequency resource, transmitting, at 1216, the DL transmission based on an increased DL transmission power of the DL transmission in the at least one harmonic frequency resource, receiving, at 1217, the UL transmission based on a reduced UL transmission power for the UL transmission in the UL resources associated with the at least one harmonic frequency resource, or transmitting, at 1218, the DL transmission based on a lower order MCS for the DL transmission in the at least one harmonic frequency resource. For example, 1214-1218 may be performed by CU processor(s) 1412, DU processor(s) 1432, RU processor(s) 1442, transceiver(s) 1446, antenna(s) 1480, and/or self-interference handling component 199 of FIG. 14. For example, referring to FIG. 8, the base station 802 may, at 822, adjust an UL reception and/or a DL transmission.

In some aspects, the adjusting at 1214 may include adjusting the transmission, at 1215, of the DL transmission in the second allocation of the DL resources, where the adjusting may be based on the DL rate matching around allocated resources that overlap with the at least one harmonic frequency resource to the UL resources. The adjusting, in some aspects, may be based on a condition related to one or more of: an occurrence of an at least partial overlap of the DL resources and the at least one harmonic frequency resource to the UL resources, a transmission of an indication for the UE to rate match the DL transmission based on the at least partial overlap of the DL resources and the at least one harmonic frequency resource to the UL resources, an MCS of the DL transmission, or a transmission power of the UL transmission. In some aspects, the condition for the adjusting may be based on (or related to) the MCS of the DL transmission or the UL transmission in comparison to an MCS threshold. The condition for the adjusting may be based on (or related to) the transmission power of the UL transmission meeting a power threshold.

In some aspects, the UL resources may include resources allocated for a reference signal, and the UL resources (e.g., the UL resources allocated for the RS) may include empty resource elements in which the reference signal is not transmitted. The adjusting, in some aspects may include the DL rate matching around resource elements in which the reference signal is transmitted and not DL rate matching around the empty resource elements in which the reference signal is not transmitted. In some aspects, adjusting of one of the UL reception in the UL resources or the transmission of the DL transmission in the DL resources may include adjusting the one of the UL reception or the DL transmission in at least one additional time resource or at least one additional frequency resource, where the at least one additional time resource or the at least one additional frequency resource may be adjacent to the at least one harmonic frequency resource to the UL resources. For example, referring to FIG. 8, at 822A, the base station 802 may perform DL rate matching around the impacted DL resources (e.g., the first set of (impacted/effected/interfered with) frequency resources or first set of “K” PRBs of the allocated DL resources that may be impacted by “J” PRBs of the allocated UL resources) and the UE 804 may receive the adjusted DL transmission and perform a corresponding adjustment to a decoding of the rate-matched DL transmission.

The adjusting at 1214, in some aspects, may include transmitting, at 1216, the DL transmission in the DL resources based on the increased DL transmission power of the DL transmission in the at least one harmonic frequency resource. In some aspects, the DL transmission may have, or be associated with, different transmission powers for the at least one harmonic frequency resource to the UL transmission and a non-harmonic frequency resource that is not harmonic to the UL resources, or the UL transmission (e.g., an increased DL transmission power for the at least one harmonic frequency resource to the UL transmission and an unchanged, or reduced, DL transmission power for the non-harmonic frequency resource to the UL resources/transmission). As discussed above, an additional indication of the increased DL transmission power associated with the at least one harmonic frequency resource to the UL transmission, and/or at least one range of frequencies in which the increased DL transmission power will be used for the DL transmission may be transmitted by the network node. For example, referring to FIG. 8, at 822B, the base station 802, in some aspects may adjust a DL transmission power of one or more DL resources of the allocated DL resources and the UE 804 may receive the adjusted DL transmission and perform a corresponding adjustment to a decoding of the adjusted DL transmission, where a power associated with the adjusted (e.g., increased) DL transmission power may be received in the self-interference avoidance/mitigation configuration 814.

In some aspects, the adjusting at 1214, may include receiving, at 1217, the UL transmission with a reduced transmission power for at least a subset of resources that have the at least one harmonic frequency resource in the DL resources. Receiving the UL transmission, in some aspects, may include receiving the UL transmission with a first transmission power in the subset of resources that have the at least one harmonic frequency resource in the DL resources, and receiving the UL transmission with a second transmission power in a resource that does not have the at least one harmonic frequency resource in the DL resources. In some aspects, the first transmission power may be lower than the second transmission power. A total power per symbol, in some aspects, may be maintained based on a different EPRE for the subset of resources that have the at least one harmonic frequency resource in the DL resources and the resource that does not have the at least one harmonic frequency resource in the DL resources. In some aspects, the reduced UL transmission power may be based on one or more of: a range of configured values, a relative priority of the DL transmission and the UL transmission, a time offset between the DL transmission and the UL transmission meeting a threshold timing offset, an UL transmit power control for power reduction based on the at least one harmonic frequency resource allocated for the DL transmission or an additional indication to reduce the UL transmission power. For example, referring to FIG. 8, the UE 804, at 822C, may adjust (or reduce) a UL transmission power of one or more UL resources of the allocated UL resources and the base station 802 may receive the adjusted UL transmission and perform a corresponding adjustment to a decoding of the adjusted UL transmission.

The adjusting at 1214, in some aspects, may include transmitting, at 1218, the DL transmission based on a lower order MCS of the DL transmission in the at least one harmonic frequency resource. In some aspects, the DL transmission may have different MCSs for the at least one harmonic frequency resource to the UL transmission and a non-harmonic frequency resource to the UL transmission (e.g., an decreased MCS for the at least one harmonic frequency resource to the UL transmission and an unchanged MCS for the non-harmonic frequency resource to the UL transmission). Transmitting the DL transmission, in some aspects, may include transmitting the DL transmission in at least the one harmonic frequency resource and an additional resource based on a first MCS, and transmitting the DL transmission in the non-harmonic frequency resource based on a second MCS, where the first MCS may be a lower order than the second MCS (e.g., an MCS index of the first MCS may be lower than an MCS index of the second MCS). For example, referring to FIG. 8, the base station 802, at 822D, in some aspects may adjust an MCS (e.g., an MCS index or MCS value) of one or more DL resources of the allocated DL resources.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize one or more antennas 1380 for communication. The cellular baseband processor(s) 1324 communicates through the transceiver(s) 1322 via the one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the self-interference handling component 198 may be configured to receive, from a network node, a first allocation of uplink (UL) resources spanning a first range of frequencies within a first frequency band, receive a second allocation of downlink (DL) resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a reception of a DL transmission in the DL resources, where the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order MCS for the DL transmission in the at least one harmonic frequency resource. The self-interference handling component 198 may be within the cellular baseband processor(s) 1324, the application processor(s) 1306, or both the cellular baseband processor(s) 1324 and the application processor(s) 1306. The self-interference handling component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, from a network node, a first allocation of uplink (UL) resources spanning a first range of frequencies within a first frequency band. The apparatus 1304, and in particular the cellular baseband processor(s) 1324 and/or the application processor(s) 1306, may include means for receiving a second allocation of downlink (DL) resources spanning a second range of frequencies within a second frequency band that includes a harmonic frequency of the first frequency band. The apparatus 1304, and in particular the cellular baseband processor(s) 1324 and/or the application processor(s) 1306, may include means for adjusting, based on the DL resources including at least one harmonic frequency resource that is harmonic to the UL resources, one or more of an UL transmission in the UL resources or a reception of a DL transmission in the DL resources, where the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order modulation and coding scheme (MCS) for the DL transmission in the at least one harmonic frequency resource. The apparatus 1304, and in particular the cellular baseband processor(s) 1324 and/or the application processor(s) 1306, may include means for transmitting a UE capability indication of whether the UE supports the adjusting the reception of the DL transmission via the DL rate matching around the DL resources that overlap with the at least one harmonic frequency resource. The apparatus 1304, and in particular the cellular baseband processor(s) 1324 and/or the application processor(s) 1306, may include means for transmitting, to the network node, an additional indication of frequency resources within the second range of frequencies that are associated with an interference from harmonic frequencies of the first range of frequencies. The apparatus 1304, and in particular the cellular baseband processor(s) 1324 and/or the application processor(s) 1306, may include means for adjusting the one of the UL transmission or the reception of the DL transmission in at least one additional time resource or at least one additional frequency resource, where the at least one additional time resource or the at least one additional frequency resource is adjacent to the at least one harmonic frequency resource. The apparatus 1304, and in particular the cellular baseband processor(s) 1324 and/or the application processor(s) 1306, may include means for receiving, from the network node, one or more of: an additional indication of the increased DL transmission power associated with the at least one harmonic frequency resource, and at least one range of frequencies in which the increased DL transmission power will be used for the DL transmission. The apparatus 1304, and in particular the cellular baseband processor(s) 1324 and/or the application processor(s) 1306, may include means for maintaining a total power per symbol based on a different energy per resource element (EPRE) for the subset of resources that have the at least one harmonic frequency resource in the DL resources and the resource that does not have the at least one harmonic frequency resource in the DL resources. The apparatus 1304, and in particular the cellular baseband processor(s) 1324 and/or the application processor(s) 1306, may include means for transmitting, to the network node, one or more additional UE capability indications of whether the UE supports one or more of: the reception of the DL transmission based on the increased DL transmission power in the at least one harmonic frequency resource, the reception of the DL transmission with the lower order MCS in the at least one harmonic frequency resource, or a transmission of the UL transmission with the reduced UL transmission power in at least one resource having the at least one harmonic frequency resource allocated for the DL transmission. The apparatus 1304, and in particular the cellular baseband processor(s) 1324 and/or the application processor(s) 1306, may include means for adjusting the reception of the DL transmission in the DL resources, where the adjusting is based on the DL rate matching around allocated resources that overlap with the at least one harmonic frequency resource to the UL resources. The apparatus 1304, and in particular the cellular baseband processor(s) 1324 and/or the application processor(s) 1306, may include means for the DL rate matching around resource elements in which the reference signal is transmitted and not DL rate matching around the empty resource elements in which the reference signal is not transmitted. The apparatus 1304, and in particular the cellular baseband processor(s) 1324 and/or the application processor(s) 1306, may include means for receiving the DL transmission in the DL resources based on the increased DL transmission power of the DL transmission in the at least one harmonic frequency resource. The apparatus 1304, and in particular the cellular baseband processor(s) 1324 and/or the application processor(s) 1306, may include means for transmitting the UL transmission with a reduced transmission power for at least a subset of resources that have the at least one harmonic frequency resource in the DL resources. The apparatus 1304, and in particular the cellular baseband processor(s) 1324 and/or the application processor(s) 1306, may include means for transmitting the UL transmission with a first transmission power in the subset of resources that have the at least one harmonic frequency resource in the DL resources, and transmitting the UL transmission with a second transmission power in a resource that does not have the at least one harmonic frequency resource in the DL resources. The apparatus 1304, and in particular the cellular baseband processor(s) 1324 and/or the application processor(s) 1306, may include means for receiving the DL transmission based on a lower order MCS of the DL transmission in the at least one harmonic frequency resource. The apparatus 1304, and in particular the cellular baseband processor(s) 1324 and/or the application processor(s) 1306, may include means for receiving the DL transmission in the at least one harmonic frequency resource and an additional resource based on a first MCS, and receiving the DL transmission in the non-harmonic frequency resource based on a second MCS. The apparatus 1304 may further include means for performing any of the aspects described in connection with the flowcharts in FIGS. 9 and 10, and/or performed by the UE in the communication flow of FIG. 8. The means may be the self-interference handling component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the self-interference handling component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, one or more antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the self-interference handling component 199 may be configured to transmit, for a UE, a first allocation of UL resources spanning a first range of frequencies within a first frequency band, transmit a second allocation of DL resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a DL transmission in the DL resources, where the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order MCS for the DL transmission in the at least one harmonic frequency resource. The self-interference handling component 199 may be within one or more processors of one or more of the CU 1410, DU 1430, and the RU 1440. The self-interference handling component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for transmitting, for a user equipment (UE), a first allocation of uplink (UL) resources spanning a first range of frequencies within a first frequency band. The network entity 1402, in some aspects, may include means for transmitting a second allocation of downlink (DL) resources spanning a second range of frequencies within a second frequency band that includes a harmonic frequency of the first frequency band. The network entity 1402, in some aspects, may include means for adjusting, based on the DL resources including at least one harmonic frequency resource that is harmonic to the UL resources, one or more of an UL reception in the first UL resources or a DL transmission in the DL resources, where the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order modulation and coding scheme (MCS) for the DL transmission in the at least one harmonic frequency resource. The network entity 1402, in some aspects, may include means for adjusting the transmitting the DL transmission in the DL resources. The network entity 1402, in some aspects, may include means for transmitting the indication for the UE to rate match the DL transmission in one of: first DL control information (DCI) scheduling the DL transmission, second DCI scheduling the UL transmission, radio resource control (RRC) signaling associated with DL semi-persistently scheduled (SPS) physical DL shared channel (PDSCH), or a medium access control (MAC) control element (CE) (MAC-CE). The network entity 1402, in some aspects, may include means for receiving a UE capability indication of whether the UE supports, at the UE, for the adjusting the DL transmission via the DL rate matching around the DL resources that overlap with the at least one harmonic frequency resource. The network entity 1402, in some aspects, may include means for receiving, from the UE, additional indication of frequency resources within the second range of frequencies that are associated with an interference from harmonic frequencies of the first range of frequencies, where the adjusting is further based on the additional indication. The network entity 1402, in some aspects, may include means for adjusting the one or more of the UL reception or the DL transmission in at least one additional time resource or at least one additional frequency resource, where the at least one additional time resource or the at least one additional frequency resource is adjacent to the at least one harmonic frequency resource to the UL resources. The network entity 1402, in some aspects, may include means for transmitting, to the UE, one or more of: an additional indication of the increased DL transmission power associated with the at least one harmonic frequency resource, and at least one range of frequencies in which the increased DL transmission power will be used for the DL transmission. The network entity 1402, in some aspects, may include means for transmitting an additional indication for the UE to transmit the UL transmission with the reduced UL transmission power for at least the subset of resources that have the at least one harmonic frequency resource in the DL resources. The network entity 1402, in some aspects, may include means for receiving, from the UE, one or more additional UE capability indications of whether the UE supports one or more of: the DL transmission based on the increased DL transmission power in the at least one harmonic frequency resource, the DL transmission associated with the lower order MCS in the at least one harmonic frequency resource, or a transmission of the UL transmission with the reduced UL transmission power in at least one resource having the at least one harmonic frequency resource allocated for the DL transmission. The network entity 1402, in some aspects, may include means for the DL rate matching around resource elements in which the reference signal is transmitted and not DL rate matching around the empty resource elements in which the reference signal is not transmitted. The network entity 1402, in some aspects, may include means for transmitting the DL transmission in the DL resources based on the increased DL transmission power of the DL transmission in the at least one harmonic frequency resource. The network entity 1402, in some aspects, may include means for receiving the UL transmission with a reduced transmission power for at least a subset of resources that have the at least one harmonic frequency resource in the DL resources. The network entity 1402, in some aspects, may include means for receiving the UL transmission with a first transmission power in the subset of resources that have the at least one harmonic frequency resource in the DL resources, and receiving the UL transmission with a second transmission power in a resource that does not have the at least one harmonic frequency resource in the DL resources. The network entity 1402, in some aspects, may include means for transmitting the DL transmission based on a lower order MCS of the DL transmission in the at least one harmonic frequency resource. The network entity 1402, in some aspects, may include means for transmitting the DL transmission in the at least one harmonic frequency resource and an additional resource based on a first MCS, and transmitting the DL transmission in the non-harmonic frequency resource based on a second MCS, where the first MCS is a lower order than the second MCS. The network entity 1402 may further include means for performing any of the aspects described in connection with the flowchart in FIGS. 11 and 12, and/or performed by the base station in the communication flow of FIG. 8. The means may be the self-interference handling component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to cases of inter-band aggregation, for which UL transmission from a UE may create self-interference to DL reception at the UE. Multiple options for performing a rate-matching are provided, such as defining rules for UE autonomous rate-matching without dynamic indication from the network. Some aspects relate to options for self-interference mitigation, such as increasing DL transmission power, decreasing UL transmission power, and/or decreasing a modulation and coding scheme (e.g., decreasing the order or index associated with the MCS) for frequencies experiencing self-interference. In some examples, a UE may be configured to receive, from a network node, a first allocation of UL resources spanning a first range of frequencies within a first frequency band, receive a second allocation of DL resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a reception of a DL transmission in the DL resources, where the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order MCS for the DL transmission in the at least one harmonic frequency resource. In some aspects, a network node, or base station, may be configured to transmit, for a UE, a first allocation of UL resources spanning a first range of frequencies within a first frequency band, transmit a second allocation of DL resources spanning a second range of frequencies within a second frequency band that includes a harmonic frequency of the first frequency band, and adjust, based on the DL resources including at least one harmonic frequency resource that is harmonic to the UL resources, one or more of an UL transmission in the UL resources or a DL transmission in the DL resources, where the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order MCS for the DL transmission in the at least one harmonic frequency resource.

Aspects presented herein help to alleviate (e.g., avoid or mitigate) inter-band self-interference at the UE in a way that avoids added UE complexity or reduction in UE flexibility. For example, the aspects presented herein help to alleviate intra-UE inter-band self-interference in ways that can be applicable for various types of UEs, including UEs having limited capabilities. The aspects presented herein may help to reduce, avoid, and/or mitigate intra-UE inter-band interference (e.g., self-interference) for FDD operation in different frequency bands, inter-band CA, and/or inter-band DC, among other examples.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, a first allocation of uplink (UL) resources spanning a first range of frequencies within a first frequency band; receiving a second allocation of downlink (DL) resources spanning a second range of frequencies within a second frequency band that includes a harmonic frequency of the first frequency band; and adjusting, based on the DL resources including at least one harmonic frequency resource that is harmonic to the UL resources, one or more of an UL transmission in the UL resources or a reception of a DL transmission in the DL resources, wherein the adjusting is associated with one or more of: receiving the DL transmission based on a DL rate matching around the at least one harmonic frequency resource, receiving the DL transmission based on an increased DL transmission power of the DL transmission in the at least one harmonic frequency resource, transmitting the UL transmission based on a reduced UL transmission power for the UL transmission in the UL resources associated with the at least one harmonic frequency resource, or receiving the DL transmission based on a lower order modulation and coding scheme (MCS) for the DL transmission in the at least one harmonic frequency resource.

Aspect 2 is the method of aspect 1, wherein the first frequency band comprises one of frequency range 1 (FR1) or a C band, and the second frequency band comprises at least part of a 6-8 GHz frequency range of frequency range 3 (FR3), and the DL resources at least partially overlap with the at least one harmonic frequency resource, wherein the UL resources and the DL resources are associated with one of inter-band carrier aggregation or inter-band dual connectivity, wherein the at least one harmonic frequency resource is a second harmonic of at least one frequency included in the first range of frequencies corresponding to the at least one harmonic frequency resource, and wherein the UL transmission is a source of self-interference associated with the reception of the DL transmission.

Aspect 3 is the method of aspect 2, wherein the adjusting comprises adjusting the reception of the DL transmission in the DL resources, wherein the adjusting is based on the DL rate matching around allocated resources that overlap with the at least one harmonic frequency resource.

Aspect 4 is the method of aspect 3, wherein a condition for the adjusting is based on one or more of: an occurrence of an at least partial overlap of the DL resources and the at least one harmonic frequency resource; an additional reception of an indication for the UE to rate match the DL transmission based on the at least partial overlap of the DL resources and the at least one harmonic frequency resource; a first MCS of the DL transmission; or a transmission power of the UL transmission.

Aspect 5 is the method of aspect 4, wherein the adjusting is based on the indication, the method further comprising receiving the indication in one of: first DL control information (DCI) scheduling the DL transmission; second DCI scheduling the UL transmission; radio resource control (RRC) signaling associated with DL semi-persistently scheduled (SPS) physical DL shared channel (PDSCH); or a medium access control (MAC) control element (CE) (MAC-CE).

Aspect 6 is the method of aspect 4, wherein the condition for the adjusting is based on one or more of the first MCS of the DL transmission or a second MCS of the UL transmission in comparison to an MCS threshold.

Aspect 7 is the method of aspect 4, wherein the condition for the adjusting is based on the transmission power of the UL transmission meeting a power threshold.

Aspect 8 is the method of any of aspects 4 to 7, further comprising: transmitting a UE capability indication of whether the UE supports the adjusting the reception of the DL transmission via the DL rate matching around the DL resources that overlap with the at least one harmonic frequency resource.

Aspect 9 is the method of any of aspects 4 to 8, further comprising: transmitting, to the network node, an additional indication of frequency resources within the second range of frequencies that are associated with an interference from harmonic frequencies of the first range of frequencies, wherein the adjusting is further based on the additional indication.

Aspect 10 is the method of any of aspects 3 to 9, wherein the UL resources comprise resources allocated for a reference signal, wherein the UL resources comprise empty resource elements in which the reference signal is not transmitted, and wherein the adjusting includes the DL rate matching around resource elements in which the reference signal is transmitted and not DL rate matching around the empty resource elements in which the reference signal is not transmitted.

Aspect 11 is the method of any of aspects 1 to 10, wherein the adjusting of one or more of the UL transmission in the first UL resources or the reception of the DL transmission in the DL resources further comprises: adjusting the one or more of the UL transmission or the reception of the DL transmission in at least one additional time resource or at least one additional frequency resource, wherein the at least one additional time resource or the at least one additional frequency resource is adjacent to the at least one harmonic frequency resource.

Aspect 12 is the method of aspect 1, wherein the adjusting comprises receiving the DL transmission in the DL resources based on the increased DL transmission power of the DL transmission in the at least one harmonic frequency resource.

Aspect 13 is the method of aspect 12, wherein the DL transmission has different transmission powers for the at least one harmonic frequency resource and a non-harmonic frequency resource.

Aspect 14 is the method of aspect 13, further comprising: receiving, from the network node, one or more of: an additional indication of the increased DL transmission power associated with the at least one harmonic frequency resource, and at least one range of frequencies in which the increased DL transmission power will be used for the DL transmission.

Aspect 15 is the method of any of aspects 1 and 11-14, wherein the adjusting comprises transmitting the UL transmission with a reduced transmission power for at least a subset of resources that have the at least one harmonic frequency resource in the DL resources.

Aspect 16 is the method of aspect 15, wherein transmitting the UL transmission includes transmitting the UL transmission with a first transmission power in the subset of resources that have the at least one harmonic frequency resource in the DL resources, and transmitting the UL transmission with a second transmission power in a resource that does not have the at least one harmonic frequency resource in the DL resources, and wherein the first transmission power is lower than the second transmission power.

Aspect 17 is the method of aspect 16, wherein transmitting the UL transmission based on the reduced UL transmission power for the UL transmission in the UL resources further comprises: maintaining a total power per symbol based on a different energy per resource element (EPRE) for the subset of resources that have the at least one harmonic frequency resource in the DL resources and the resource that does not have the at least one harmonic frequency resource in the DL resources.

Aspect 18 is the method of any of aspects 16 and 17, wherein the reduced UL transmission power is based on one or more of: a range of configured values; a relative priority of the DL transmission and the UL transmission; a time offset between the DL transmission and the UL transmission meeting a threshold timing offset; an UL transmit power control for power reduction based on the at least one harmonic frequency resource allocated for the DL transmission; or an additional indication to reduce an UL transmission power.

Aspect 19 is the method of any of aspects 1 and 11 to 18, wherein the adjusting comprises receiving the DL transmission based on a lower order MCS of the DL transmission in the at least one harmonic frequency resource.

Aspect 20 is the method of aspect 19, wherein the DL transmission has different MCSs for the at least one harmonic frequency resource and a non-harmonic frequency resource that is not harmonic to the UL resources.

Aspect 21 is the method of aspect 20, wherein receiving the DL transmission includes receiving the DL transmission in the at least one harmonic frequency resource and an additional resource based on a first MCS, and receiving the DL transmission in the non-harmonic frequency resource based on a second MCS, wherein the first MCS is a lower order than the second MCS.

Aspect 22 is the method of any of aspects 1 to 21, further comprising: transmitting, to the network node, one or more additional UE capability indications of whether the UE supports one or more of: the reception of the DL transmission based on the increased DL transmission power in the at least one harmonic frequency resource, the reception of the DL transmission with the lower order MCS in the at least one harmonic frequency resource, or a transmission of the UL transmission with the reduced UL transmission power in at least one resource having the at least one harmonic frequency resource allocated for the DL transmission.

Aspect 23 is a method of wireless communication at a network node, comprising: transmitting, for a user equipment (UE), a first allocation of uplink (UL) resources spanning a first range of frequencies within a first frequency band; transmitting a second allocation of downlink (DL) resources spanning a second range of frequencies within a second frequency band that includes a harmonic frequency of the first frequency band; and adjusting, based on the DL resources including at least one harmonic frequency resource that is harmonic to the UL resources, one or more of an UL transmission in the first UL resources or a DL transmission in the DL resources, wherein the adjusting is associated with one or more of: transmitting the DL transmission based on a DL rate matching around the at least one harmonic frequency resource, transmitting the DL transmission based on an increased DL transmission power of the DL transmission in the at least one harmonic frequency resource, receiving the UL transmission based on a reduced UL transmission power for the UL transmission in the UL resources associated with the at least one harmonic frequency resource, or transmitting the DL transmission based on a lower order modulation and coding scheme (MCS) for the DL transmission in the at least one harmonic frequency resource.

Aspect 24 is the method of aspect 23, wherein the first frequency band comprises one of frequency range 1 (FR1) or a C band, and the second frequency band comprises at least part of a 6-8 GHz frequency range of frequency range 3 (FR3), and the DL resources at least partially overlap with the at least one harmonic frequency resource, wherein the UL resources and the DL resources are associated with one of inter-band carrier aggregation or inter-band dual connectivity, wherein the at least one harmonic frequency resource is a second harmonic of at least one frequency included in the first range of frequencies corresponding to the at least one harmonic frequency resource, and wherein the UL transmission is a source of self-interference associated with a reception of the DL transmission at the UE.

Aspect 25 is the method of aspect 24, wherein the adjusting comprises adjusting the transmitting the DL transmission in the DL resources, wherein the adjusting is based on the DL rate matching around allocated resources that overlap with the at least one harmonic frequency resource.

Aspect 26 is the method of aspect 25, wherein a condition for the adjusting is based on one or more of: an occurrence of an at least partial overlap of the DL resources and the at least one harmonic frequency resource; an additional transmission of an indication for the UE to rate match the DL transmission based on the at least partial overlap of the DL resources and the at least one harmonic frequency resource; a first MCS of the DL transmission; or a transmission power of the UL transmission.

Aspect 27 is the method of aspect 26, wherein the adjusting is based on the indication, the method further comprising transmitting the indication in one of: first DL control information (DCI) scheduling the DL transmission; second DCI scheduling the UL transmission; radio resource control (RRC) signaling associated with DL semi-persistently scheduled (SPS) physical DL shared channel (PDSCH); or a medium access control (MAC) control element (CE) (MAC-CE).

Aspect 28 is the method of aspect 26, wherein the condition for the adjusting is based on one or more of the first MCS of the DL transmission or a second MCS of the UL transmission in comparison to an MCS threshold.

Aspect 29 is the method of aspect 26, wherein the condition for the adjusting is based on the transmission power of the UL transmission meeting a power threshold.

Aspect 30 is the method of any of aspects 26-29, further comprising: receiving a UE capability indication of whether the UE supports, at the UE, the adjusting the DL transmission via the DL rate matching around the DL resources that overlap with the at least one harmonic frequency resource.

Aspect 31 is the method of any of aspects 26-30, further comprising: receiving, from the UE, an additional indication of frequency resources within the second range of frequencies that are associated with an interference from harmonic frequencies of the first range of frequencies, wherein the adjusting is further based on the additional indication.

Aspect 32 is the method of any of aspects 25 to 31, wherein the UL resources comprise resources allocated for a reference signal, wherein the UL resources comprise empty resource elements in which the reference signal is not transmitted, and wherein the adjusting includes the DL rate matching around resource elements in which the reference signal is transmitted and not DL rate matching around the empty resource elements in which the reference signal is not transmitted.

Aspect 33 is the method of any of aspects 23 to 32, wherein the adjusting of one or more of the UL transmission in the first UL resources or the DL transmission in the DL resources further comprises: adjusting the one or more of the UL transmission or the DL transmission in at least one additional time resource or at least one additional frequency resource, wherein the at least one additional time resource or the at least one additional frequency resource is adjacent to the at least one harmonic frequency resource.

Aspect 34 is the method of aspect 23, wherein the adjusting comprises transmitting the DL transmission in the DL resources based on the increased DL transmission power of the DL transmission in the at least one harmonic frequency resource.

Aspect 35 is the method of aspect 34, wherein the DL transmission has different transmission powers for the at least one harmonic frequency resource and a non-harmonic frequency resource that is not harmonic to the UL resources.

Aspect 36 is the method of aspect 35, further comprising: transmitting, to the UE, one or more of: an additional indication of the increased DL transmission power associated with the at least one harmonic frequency resource, and at least one range of frequencies in which the increased DL transmission power will be used for the DL transmission.

Aspect 37 is the method of any of aspects 23 and 33-36, wherein the adjusting comprises receiving the UL transmission with a reduced transmission power for at least a subset of resources that have the at least one harmonic frequency resource in the DL resources, the method further comprising: transmitting an additional indication for the UE to transmit the UL transmission with the reduced UL transmission power for at least the subset of resources that have the at least one harmonic frequency resource in the DL resources.

Aspect 38 is the method of aspect 37, wherein receiving the UL transmission includes receiving the UL transmission with a first transmission power in the subset of resources that have the at least one harmonic frequency resource in the DL resources, and receiving the UL transmission with a second transmission power in a resource that does not have the at least one harmonic frequency resource in the DL resources, and wherein the first transmission power is lower than the second transmission power.

Aspect 39 is the method of aspect 38, wherein a total power per symbol is maintained based on a different energy per resource element (EPRE) for the subset of resources that have the at least one harmonic frequency resource in the DL resources and the resource that does not have the at least one harmonic frequency resource in the DL resources.

Aspect 40 is the method of any of aspects 38 and 39, wherein the reduced UL transmission power is based on one of: a range of configured values; a relative priority of the DL transmission and the UL transmission; a time offset between the DL transmission and the UL transmission meeting a threshold timing offset; or an UL transmit power control for power reduction based on the at least one harmonic frequency resource allocated for the DL transmission.

Aspect 41 is the method of any of aspects 23 and 33-41, wherein the adjusting comprises transmitting the DL transmission based on a lower order MCS of the DL transmission in the at least one harmonic frequency resource.

Aspect 42 is the method of aspect 41, wherein the DL transmission has different MCSs for the at least one harmonic frequency resource and a non-harmonic frequency resource that is not harmonic to the UL resources.

Aspect 43 is the method of aspect 42, wherein transmitting the DL transmission includes transmitting the DL transmission in the at least one harmonic frequency resource and an additional resource based on a first MCS, and transmitting the DL transmission in the non-harmonic frequency resource based on a second MCS, wherein the first MCS is a lower order than the second MCS.

Aspect 44 is the method of any of aspects 23 to 43, further comprising: receiving, from the UE, one or more additional UE capability indications of whether the UE supports one or more of: the DL transmission based on the increased DL transmission power in the at least one harmonic frequency resource, the DL transmission associated with the lower order MCS in the at least one harmonic frequency resource, or a transmission of the UL transmission with the reduced UL transmission power in at least one resource having the at least one harmonic frequency resource allocated for the DL transmission.

Aspect 45 is an apparatus for wireless communication at a UE, comprising: at least one memory; and at least one processor coupled to the at least one memory, the at least one processor is configured to perform the method of any of aspects 1 to 22.

Aspect 46 is an apparatus for wireless communication at a UE, comprising means for performing each step in the method of any of aspects 1 to 22.

Aspect 47 is the apparatus of any of aspects 45 to 46, further comprising a transceiver configured to receive or to transmit in association with the method of any of aspects 1 to 22.

Aspect 48 is a computer-readable medium storing computer executable code at a UE, the code when executed by at least one processor causes the at least one processor to perform the method of any of aspects 1 to 22.

Aspect 49 is an apparatus for wireless communication at a network node, comprising: at least one memory; and at least one processor coupled to the at least one memory, the at least one processor is configured to perform the method of any of aspects 23 to 44.

Aspect 50 is an apparatus for wireless communication at a network node, comprising means for performing each step in the method of any of aspects 23 to 44.

Aspect 51 is the apparatus of any of aspects 49 to 50, further comprising a transceiver configured to receive or to transmit in association with the method of any of aspects 23 to 44.

Aspect 52 is a computer-readable medium storing computer executable code at a network node, the code when executed by at least one processor causes the at least one processor to perform the method of any of aspects 23 to 44.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network node, a first allocation of uplink (UL) resources spanning a first range of frequencies within a first frequency band;
receive a second allocation of downlink (DL) resources spanning a second range of frequencies within a second frequency band that includes a harmonic frequency of the first frequency band; and
adjust, based on the DL resources including at least one harmonic frequency resource that is harmonic to the UL resources, one or more of an UL transmission in the UL resources or a reception of a DL transmission in the DL resources, wherein to adjust the one or more of the UL transmission or the reception of the DL transmission, the at least one processor, individually or in any combination, is further configured to one or more of:
receive the DL transmission based on a DL rate matching around the at least one harmonic frequency resource,
receive the DL transmission based on an increased DL transmission power of the DL transmission in the at least one harmonic frequency resource,
transmit the UL transmission based on a reduced UL transmission power for the UL transmission in the UL resources associated with the at least one harmonic frequency resource, or
receive the DL transmission based on a lower order modulation and coding scheme (MCS) for the DL transmission in the at least one harmonic frequency resource.

2. The apparatus of claim 1, wherein the first frequency band comprises one of frequency range 1 (FR1) or a C band, and the second frequency band comprises at least part of a 6-8 GHz frequency range of frequency range 3 (FR3), and the DL resources at least partially overlap with the at least one harmonic frequency resource, wherein the UL resources and the DL resources are associated with one of inter-band carrier aggregation or inter-band dual connectivity, wherein the at least one harmonic frequency resource is a second harmonic of at least one frequency included in the first range of frequencies corresponding to the at least one harmonic frequency resource, and wherein the UL transmission is a source of self-interference associated with the reception of the DL transmission.

3. The apparatus of claim 2, wherein, to adjust one or more of the UL transmission or the reception of the DL transmission, the at least one processor, individually or in any combination, is further configured to adjust the reception of the DL transmission in the DL resources based on the DL rate matching around allocated resources that overlap with the at least one harmonic frequency resource.

4. The apparatus of claim 3, wherein a condition to adjust one or more of the UL transmission or the reception of the DL transmission is based on one or more of:
an occurrence of an at least partial overlap of the DL resources and the at least one harmonic frequency resource;
an additional reception of an indication for the UE to rate match the DL transmission based on the at least partial overlap of the DL resources and the at least one harmonic frequency resource;
a first MCS of the DL transmission; or
a transmission power of the UL transmission.

5. The apparatus of claim 4, wherein, to adjust the one or more of the UL transmission or the reception of the DL transmission, the at least one processor, individually or in any combination, is further configured to adjust the one or more of the UL transmission or the reception of the DL transmission based on the indication, wherein the at least one processor, individually or in any combination, is further configured to receive the indication in one of:
first DL control information (DCI) scheduling the DL transmission;
second DCI scheduling the UL transmission;
radio resource control (RRC) signaling associated with DL semi-persistently scheduled (SPS) physical DL shared channel (PDSCH); or
a medium access control (MAC) control element (CE) (MAC-CE).

6. The apparatus of claim 4, wherein the condition to adjust the one or more of the UL transmission or the reception of the DL transmission is based on one or more of the first MCS of the DL transmission or a second MCS of the UL transmission in comparison to an MCS threshold.

7. The apparatus of claim 4, wherein the condition to adjust the one or more of the UL transmission or the reception of the DL transmission is based on the transmission power of the UL transmission meeting a power threshold.

8. The apparatus of claim 4, wherein the at least one processor, individually or in any combination, is further configured to:
transmit a UE capability indication of whether the UE supports an adjustment of the reception of the DL transmission via the DL rate matching around the DL resources that overlap with the at least one harmonic frequency resource.

9. The apparatus of claim 4, wherein the at least one processor, individually or in any combination, is further configured to:
transmit, to the network node, an additional indication of frequency resources within the second range of frequencies that are associated with an interference from harmonic frequencies of the first range of frequencies, wherein to adjust the one or more of the UL transmission or the reception of the DL transmission, the at least one processor, individually or in any combination, is further configured to adjust the one or more of the UL transmission or the reception of the DL transmission based on the additional indication.

10. The apparatus of claim 3, wherein the UL resources comprise resources allocated for a reference signal, wherein the UL resources comprise empty resource elements in which the reference signal is not transmitted, and wherein to adjust the one or more of the UL transmission or the reception of the DL transmission, the at least one processor, individually or in any combination, is further configured to adjust the one or more of the UL transmission or the reception of the DL transmission based on the DL rate matching around resource elements in which the reference signal is transmitted and not DL rate matching around the empty resource elements in which the reference signal is not transmitted.

11. The apparatus of claim 1, wherein, to adjust the one or more of the UL transmission or the reception of the DL transmission, the at least one processor, individually or in any combination, is further configured to:
adjust the one or more of the UL transmission or the reception of the DL transmission in at least one additional time resource or at least one additional frequency resource, wherein the at least one additional time resource or the at least one additional frequency resource is adjacent to the at least one harmonic frequency resource.

12. The apparatus of claim 1, wherein, to receive the DL transmission in the DL resources based on the increased DL transmission power of the DL transmission in the at least one harmonic frequency resource, the at least one processor, individually or in any combination, is further configured to receive the DL transmission with different transmission powers for the at least one harmonic frequency resource and a non-harmonic frequency resource, and the at least one processor, individually or in any combination, is further configured to:
receive, from the network node, one or more of:
an additional indication of the increased DL transmission power associated with the at least one harmonic frequency resource, and
at least one range of frequencies in which the increased DL transmission power will be used for the DL transmission.

13. The apparatus of claim 1, wherein to transmit the UL transmission the at least one processor, individually or in any combination, is further configured to transmit the UL transmission with a first transmission power in a subset of the UL resources that have the at least one harmonic frequency resource in the DL resources, and transmit the UL transmission with a second transmission power in a resource that does not have the at least one harmonic frequency resource in the DL resources, wherein the first transmission power is lower than the second transmission power, and wherein the reduced UL transmission power is based on one or more of:
a range of configured values;
a relative priority of the DL transmission and the UL transmission;
a time offset between the DL transmission and the UL transmission meeting a threshold timing offset;
an UL transmit power control for power reduction based on the at least one harmonic frequency resource allocated for the DL transmission; or
an additional indication to reduce an UL transmission power.

14. The apparatus of claim 13, wherein to transmit the UL transmission based on the reduced UL transmission power for the UL transmission in the UL resources, the at least one processor, individually or in any combination, is further configured to:
maintain a total power per symbol based on a different energy per resource element (EPRE) for the subset of resources that have the at least one harmonic frequency resource in the DL resources and the resource that does not have the at least one harmonic frequency resource in the DL resources.

15. The apparatus of claim 1, wherein to receive the DL transmission based on a lower order MCS of the DL transmission in the at least one harmonic frequency resource, the at least one processor, individually or in any combination, is further configured to receive the DL transmission with a first MCS for the at least one harmonic frequency resource and a second MCS for a non-harmonic frequency resource that is not harmonic to the UL resources.

16. The apparatus of claim 15, wherein to receive the DL transmission based on a lower order MCS of the DL transmission in the at least one harmonic frequency resource, the at least one processor, individually or in any combination, is further configured to receive a first portion of the DL transmission in the at least one harmonic frequency resource and an additional resource based on the first MCS, and receive a second portion of the DL transmission in the non-harmonic frequency resource based on the second MCS, wherein the first MCS is a lower order than the second MCS.

17. The apparatus of claim 1, wherein the at least one processor, individually or in any combination, is further configured to:
transmit, to the network node, one or more additional UE capability indications of whether the UE supports one or more of:
the reception of the DL transmission based on the increased DL transmission power in the at least one harmonic frequency resource,
the reception of the DL transmission with the lower order MCS in the at least one harmonic frequency resource, or
a transmission of the UL transmission with the reduced UL transmission power in at least one resource having the at least one harmonic frequency resource allocated for the DL transmission.

18. A method of wireless communication at a user equipment (UE), comprising:
receiving, from a network node, a first allocation of uplink (UL) resources spanning a first range of frequencies within a first frequency band;
receiving a second allocation of downlink (DL) resources spanning a second range of frequencies within a second frequency band that includes a harmonic frequency of the first frequency band; and
adjusting, based on the DL resources including at least one harmonic frequency resource that is harmonic to the UL resources, one or more of an UL transmission in the UL resources or a reception of a DL transmission in the DL resources, wherein the adjusting is associated with one or more of:
receiving the DL transmission based on a DL rate matching around the at least one harmonic frequency resource,
receiving the DL transmission based on an increased DL transmission power of the DL transmission in the at least one harmonic frequency resource,
transmitting the UL transmission based on a reduced UL transmission power for the UL transmission in the UL resources associated with the at least one harmonic frequency resource, or
receiving the DL transmission based on a lower order modulation and coding scheme (MCS) for the DL transmission in the at least one harmonic frequency resource.

19. The method of claim 18, wherein the first frequency band comprises one of frequency range 1 (FR1) or a C band, and the second frequency band comprises at least part of a 6-8 GHz frequency range of frequency range 3 (FR3), and the DL resources at least partially overlap with the at least one harmonic frequency resource, wherein the UL resources and the DL resources are associated with one of inter-band carrier aggregation or inter-band dual connectivity, wherein the at least one harmonic frequency resource is a second harmonic of at least one frequency included in the first range of frequencies corresponding to the at least one harmonic frequency resource, and wherein the UL transmission is a source of self-interference associated with the reception of the DL transmission.

20. A computer-readable medium storing computer executable code at a user equipment (UE), the code when executed by at least one processor causes the at least one processor to:
receive, from a network node, a first allocation of uplink (UL) resources spanning a first range of frequencies within a first frequency band;
receive a second allocation of downlink (DL) resources spanning a second range of frequencies within a second frequency band that includes a harmonic frequency of the first frequency band; and
adjust, based on the DL resources including at least one harmonic frequency resource that is harmonic to the UL resources, one or more of an UL transmission in the UL resources or a reception of a DL transmission in the DL resources, wherein to adjust the one or more of the UL transmission or the reception of the DL transmission, the code when executed by the at least one processor causes the at least one processor to one or more of:
receive the DL transmission based on a DL rate matching around the at least one harmonic frequency resource,
receive the DL transmission based on an increased DL transmission power of the DL transmission in the at least one harmonic frequency resource,
transmit the UL transmission based on a reduced UL transmission power for the UL transmission in the UL resources associated with the at least one harmonic frequency resource, or
receive the DL transmission based on a lower order modulation and coding scheme (MCS) for the DL transmission in the at least one harmonic frequency resource.
